(19) United States
(12) Patent Application Publication
(10) Pub. No.: US 2024/0305661 A1
(43) Pub. Date: Sep. 12, 2024

(54) METHODS AND APPARATUS TO OPTIMIZE ATTESTATION VERIFICATION

(71) Applicant: Intel Corporation, Santa Clara, CA (US)

(72) Inventor: Ned M. Smith, Beaverton, OR (US)

(21) Appl. No.: 18/666,567

(22) Filed: May 16, 2024

Related U.S. Application Data
(60) Provisional application No. 63/614,479, filed on Jan. 12, 2024.

(51) Int. Cl. H04L 9/40

(52) U.S. Cl. CPC H04L 63/1433

(57) ABSTRACT

Systems, apparatus, articles of manufacture, and methods are disclosed to optimize attestation verification. An example method includes determining a first network of nodes from attestation evidence, a node of the first network of nodes associated with an appraisal context of an device, obtaining an endorsement for the device, determining a second network of nodes from the endorsements, identifying a node that is in the first network of nodes and the second network of nodes, combining the first network of nodes and the second network of nodes to form a third network of nodes, and generating an attestation result for the device from the third network of nodes.

### RELATED APPLICATION

This patent claims the benefit of U.S. Provisional Patent Application No. 63/614,479, which was filed on Jan. 12, 2024. U.S. Provisional Patent Application No. 63/614,479 is hereby incorporated herein by reference in its entirety. Priority to U.S. Provisional Patent Application No. 63/614,479 is hereby claimed.

### BACKGROUND

In exchanges between remote devices, it is often important for a device to know the security state of another device. The security state of a device is a classification of the operating conditions of the device as they pertain to security risks such as malware infections. For example, a device can be classified as being in a “bad” or “untrusted” security state if it is determined that a malicious application is running on the device, if it is determined the device is running an untrusted operating system, if it is determined that the device has been accessed by a malicious entity, etc. Attestation may be used to assert the security state of a computing environment of a device. Attestation involves measuring a component of a computing environment of a device, signing the measurement, and sending the signed measurement to a relying party.

### BRIEF DESCRIPTION OF THE DRAWINGS

FIG. 1 is a block diagram of an example environment in which an example verifier circuitry operates to generate attestation results.

FIG. 2 is a block diagram of an example implementation of the verifier circuitry of FIG. 1.

FIG. 3 is a conceptual diagram illustrating an example attester system.

FIG. 4 is a flowchart representative of example machine readable instructions and/or example operations that may be executed, instantiated, and/or performed by example programmable circuitry to implement the verifier circuitry of FIG. 1.

FIG. 5 is a flowchart representative of example machine readable instructions and/or example operations that may be executed, instantiated, and/or performed by example programmable circuitry to implement the verifier circuitry of FIG. 1.

FIG. 6 is a conceptual diagram illustrating a combination of bottom-up and top-down description of another example attester system 600.

FIG. 7 is a conceptual diagram illustrating an example combined network of nodes generated by the verifier circuitry of FIG. 1.

FIG. 8 illustrates example endorsements provided by an endorser for an attester for an example static composition, direct enforcement use case.

FIG. 9 illustrates an example ACS generated by the verifier circuitry of FIG. 1 for an attester for the example static composition, direct enforcement use case of FIG. 8.

FIG. 10 illustrates example endorsements provided by an endorser for an attester and example attestation evidence from the attester for an example evidence matching use case.

FIG. 11 illustrates an example ACS generated by the verifier circuitry of FIG. 1 for an attester for the example evidence matching use case of FIG. 10.

FIG. 12 illustrates an example NIC ACS generated by the verifier circuitry of FIG. 1 for a NIC of an attester for an example simple endorsement use case.

FIG. 13 illustrates an example ACS generated by the verifier circuitry of FIG. 1 for an attester for the example simple endorsement use case of FIG. 12.

FIG. 14 illustrates example endorsements from an OEM manufacturer, example endorsements and reference values from a motherboard manufacturer, example attestation evidence from a first attester, and example attestation evidence from a second attester for an example update and patch use case.

FIG. 15 illustrates an example ACS generated by the verifier circuitry of FIG. 1 for an attester for the example update and patch use case of FIG. 14.

FIG. 16 illustrates example endorsements and reference values provided by a NIC manufacturer for a NIC of an attester and attestation evidence provided by the attester for an example dynamic composition use case.

FIG. 17 illustrates an example ACS generated by the verifier circuitry of FIG. 1 for an attester for the example dynamic composition use case of FIG. 16.

FIG. 18 illustrates an example NIC ACS generated by the verifier circuitry of FIG. 1 for a NIC of an attester for an example conditional endorsement use case.

FIG. 19 illustrates an example ACS generated by the verifier circuitry of FIG. 1 for an attester for the example conditional endorsement use case of FIG. 18.

FIG. 20 illustrates an example NIC ACS generated by the verifier circuitry of FIG. 1 for a NIC of an attester for an example conditional endorsement series use case.

FIG. 21 illustrates an example ACS generated by the verifier circuitry of FIG. 1 for an attester for the example conditional endorsement series use case of FIG. 20.

FIG. 22 illustrates an example NIC ACS generated by the verifier circuitry of FIG. 1 for a NIC of an attester for an example multi-endorsement use case.

FIG. 23 illustrates an example ACS generated by the verifier circuitry of FIG. 1 for an attester for the example multi-endorsement use case of FIG. 22.

FIG. 24 illustrates an example NIC ACS generated by the verifier circuitry of FIG. 1 for a NIC of an attester for an example conditional endorsement with authority use case.

FIG. 25 illustrates an example ACS generated by the verifier circuitry of FIG. 1 for an attester for the example conditional endorsement with authority use case of FIG. 24.

FIG. 26 illustrates example endorsements and reference values provided by an independent software vendor (ISV) for software of an attester and attestation evidence provided by the attester for an example concise SWID (CoSWID) matching use case.

FIG. 27 illustrates an example ACS generated by the verifier circuitry of FIG. 1 for an attester for the example CoSWID matching use case of FIG. 26.

FIG. 28 illustrates an example ACS generated by the verifier circuitry of FIG. 1 for an attester after the verifier circuitry stages shown in FIGS. 8-27.

FIG. 29 illustrates an example ACS generated by the verifier circuitry of FIG. 1 for an attester after application of an appraisal policy.

FIG. 30 illustrates example verifier asserted claims generated by the verifier circuitry of FIG. 1

FIG. 31 illustrates an example final ACS generated by the verifier circuitry of FIG. 1 for an attester in a final state.

FIG. 32 is a block diagram of an example processing platform including programmable circuitry structured to execute, instantiate, and/or perform the example machine readable instructions and/or perform the example operations of FIGS. 4 and 5 to implement the verifier circuitry of FIG. 2.

FIG. 33 is a block diagram of an example implementation of the programmable circuitry of FIG. 32

FIG. 34 is a block diagram of another example implementation of the programmable circuitry of FIG. 32.

FIG. 35 is a block diagram of an example software/firmware/instructions distribution platform (e.g., one or more servers) to distribute software, instructions, and/or firmware (e.g., corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In trusted computing, attestation is the process of ensuring another system can be trusted. Whether a system can be trusted is a determination made by a relying party (or a trusted intermediary) based on relevant information, such as the operating state of the system. A trusted system is one that is determined to be able to perform intended functions without compromising the security of sensitive information or performing malicious acts. In some environments, only trusted systems are allowed access to data or certain network privileges. Systems that fail to prove they are trustworthy can be denied access, flagged as untrustworthy, or otherwise isolated. In an example arrangement, a first system (e.g., an attester, attester device) that wants to access sensitive data and/or gain certain privileges produces information about itself (e.g., attestation evidence, attestation data, etc.), including claims about the operating state of the attester, to enable a second system (e.g., a relying party, relying device) to evaluate the trustworthiness of the first system. This process can be facilitated by an additional party (e.g., a verifier) that appraises evidence according to a set of rules (e.g., appraisal policies) and produces attestation results to the relying party. The verifier relies on endorsements about the attester device and compares the attestation evidence with reference values according to the appraisal policies. If the comparison satisfies the verifier, the verifier accepts the claims made by the attester device and then uses the accepted claims to evaluate further attestation evidence produced by the attester device. An endorsement is a secure statement from a third-party vouching for the integrity of the attester device and its attestation capabilities. Reference values and endorsements are typically provided by a manufacturer of a component on the attester device that generated the attestation evidence.

Attestation evidence (e.g., attestation data, etc.), reference values, and endorsements may exist in many manifest, token, and certificate formats (e.g., extensible markup language (XML), HyperText Markup Language (HTML), Concise Binary Object Representation (CBOR) Web token (CWT), JavaScript Object Notation (JSON) Web Token (JWT), Security Protocols and Data Models (SPDM), Entity Attestation Token (EAT), Abstract Syntax Notation One (ASN.1), Open Policy Agent (OPA)/REGO, binary, etc.). Attestation evidence behind the various formats follows a schema or convention that defines how to relate evidence with reference values and endorsements with accepted claims. Example schemas/conventions include Software Identification (SWID) Tagging, Concise Reference Integrity Manifest (CoRIM), Trusted Platform Module (TPM), X.509, and Trusted Computing Group (TCG) Platform Certificate, for example.

Staging various formats for attestation appraisals can result in different results by different independent verifiers. Consequently, in an ecosystem of attestation enabled authentication, authorization, workload processing, micro function processing, network function virtualization (NFV), containers, content defined networks (CDN), etc., inconsistent attestation results may be generated, causing these infrastructures to have inconsistent trustworthiness attribution which leads to improper resource management and control outcomes.

Methods, systems, and apparatus disclosed herein accept inputs from an attester device and/or various supply chain entities to produce a detailed representation of the operating state of the attester device including properties that indicate the trustworthiness of the attester device. Methods, systems, and apparatus disclosed herein describe an attester device operating state using a network of nodes (e.g., an appraisal context hierarchy (ACH), a node topology graph) generated by traversing and populating the network from a bottom-up and a top-down traversal algorithm. One or more nodes of the network correspond to an appraisal context of the attester device. An appraisal context is a namespace where attestation evidence is partitioned or distributed and where device composition can be organized to support attestation appraisal. Methods, systems, and apparatus disclosed herein extract appraisal context information from attestation evidence, reference values, and endorsements to create node metadata for use in generation of a node in the network. Methods, systems, and apparatus disclosed herein combine upstream attestation processes (e.g., RFC9334 “lead Attester” or SPDM requestor/responder, etc.) and device composition logics (e.g., ontology, taxonomy logics) provided by system integrators, OEMS, suppliers, or value-added providers (e.g., value-added re-sellers (VAR)) that assemble systems from off-the-shelf or build-to-order systems. Methods, systems, and apparatus disclosed herein generate attestation results based on the representation of the operating state of the attester device and appraisal policies.

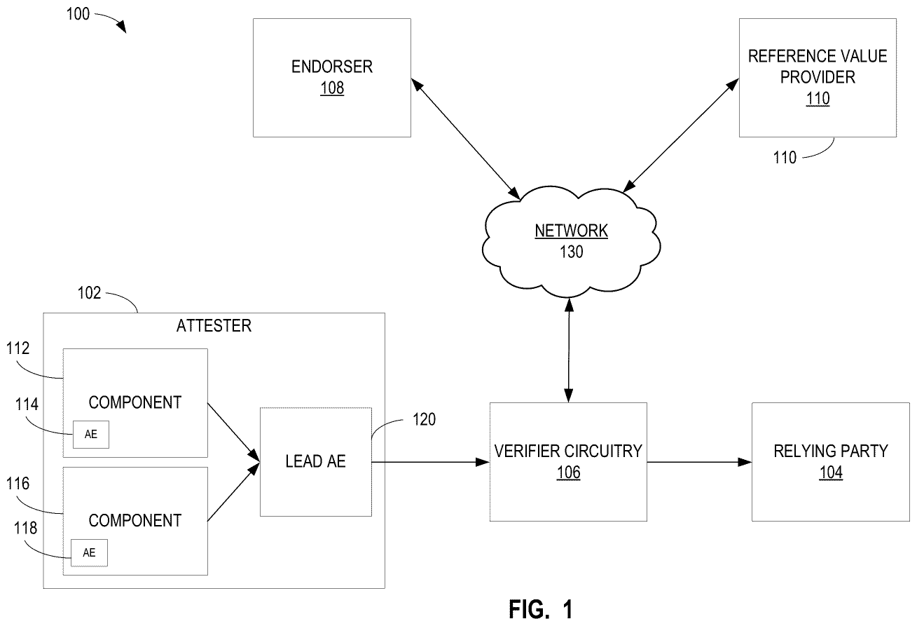

FIG. 1 is a block diagram of an example environment 100 in which an example verifier circuitry 106 operates to generate attestation results. The example environment 100 includes an example attester 102, an example relying party 104, the example verifier circuitry 106, an example endorser 108, an example reference value provider 110, and an example network 130.

The example attester 102 is a computing device such as a server, a personal computer, a workstation, a mobile device, or any other type of computing device. In some examples, the attester 102 is an application executed on a computing device. The example attester 102 includes an example first component 112 having an example first attesting environment 114, a second component 116 having a second attesting environment 118, and an example attestation compiler 120. A component is a functional building block of the attester, such as a CPU, a network interface card (NIC), etc. In some examples, the attester 102 includes more (e.g., three, four, etc.) or fewer (e.g., one) components. An attesting environment (AE) is component measurement collection capabilities and signing capabilities of a component of the attester 102. In some examples, the attester 102 does not include an attestation compiler 120. In some examples, the attester 102 includes more than one attestation compiler 120 and/or more than one connection to the verifier circuitry 106. In some examples, the attestation compiler 120 is implemented by one of the attesting environments 114-118.

The example attester 102 generates attestation evidence about itself to enable the relying party 104 to evaluate the trustworthiness of the attester 102. The attestation evidence includes claims about the operating state of the attester 102. In the illustrated example of FIG. 1, the first and second attesting environments 114, 118 generate the attestation evidence about the components of the attester 102. The attester 102 sends the attestation evidence to the verifier circuitry 106. In the example of FIG. 1, the first and second attesting environments 114, 118 send the attestation evidence to the attestation compiler 120. The attestation compiler 120 aggregates the attestation evidence and sends the attestation evidence to the verifier circuitry 106. In some examples, the attester 102 does not include an attestation compiler 120. In those examples, the attesting environments 114-118 send the attestation evidence directly to the verifier circuitry 106.

The example relying party 104 is network equipment (such as a router, switch, or an access point). In some examples, the relying party is a computing device, a website or a mobile application, a server or a service, an entity, an application, and/or any other device or entity that controls access to sensitive data and/or privileges.

The example relying party 104 makes a determination of the trustworthiness of the attester 102 based on the evidence offered by the attester 102, reference values, and endorsements. The relying party 104 makes a decision to allow (e.g., grant, permit, etc.) access to sensitive data or privileges to the attester 102 based on the determination of trustworthiness of the attester 102. In the illustrated example of FIG. 1, the relying party 104 makes the determination of the trustworthiness of the attester 102 based on attestation results generated by the verifier circuitry 106 and a set of rules (e.g., attestation results appraisal policy) for evaluating attestation results. In some examples, the attestation results appraisal policy is provided by an owner of the relying party 104. In some examples, the relying party 104 provides the attestation results appraisal policy to the verifier circuitry 106 to communicate a desired format or desired content of attestation results.

The example verifier circuitry 106 is a computing device such as a server, a personal computer, a workstation, a mobile device, or any other type of computing device. In some examples, the verifier circuitry 106 is an application. In some examples, the verifier circuitry 106 is an Application-Specific Integrated Circuit, an XPU, a Field-Programmable Gate Array, and other any other processor circuitry and/or combination of processor circuitries. In the illustrated example of FIG. 1, the verifier circuitry is communicatively connected to the attester 102, the relying party 104, and the endorser 108 and the reference value provider 110 via the network 130. However, the verifier circuitry 106 Although in the example of FIG. 1, the leakage verifier circuitry 106 obtains the endorsements from the endorser 108 and the reference values from the reference value 110 via the network 130, other communicative pathways can be used to transmit the data. For example, in some examples, the verifier circuitry 106 can directly access databases of the endorser 108 and the reference value provider 110 and/or (e.g., directly) receive the endorsements from the endorser 108 and the reference values from the reference value provider 110. In some examples, the verifier circuitry 106 is a trusted computing environment on the attester 102. In some examples, the verifier circuitry 106 is implemented by the relying party 104.

The example verifier circuitry 106 requests and/or otherwise obtains attestation evidence from the attester 102, endorsements from the endorser 108, and reference values from the reference value provider 110. In some examples, the verifier circuitry 106 identifies a format of the attestation evidence, reference values, and endorsement and processes the attestation evidence, reference values, and endorsement based on the identified format. In some examples, the verifier circuitry 106 identifies the type of endorsement (e.g., a direct endorsement or a conditional endorsement) and processes the endorsements based on their types. A conditional endorsement is an endorsement which is only applied if the attester is in a certain operating state. A direct endorsement endorses the attester without depending on a specific attester state. The verifier circuitry 106 extracts appraisal context information from the attestation evidence, the reference values, and the endorsements. In some examples, appraisal context information includes properties (e.g., name (e.g., UUID, OID, URI), parameters (e.g., a range of possible contexts), type) of an appraisal context. The verifier circuitry 106 creates appraisal context metadata from the appraisal context information. The following CDDL describes examples of ACH metadata:

ACH meta-data = {
? appraisal-context-name => $name
? appraisal-context-parameters => $parameters
? appraisal-context-type => $type
}
$name /= UUID, $name /= OID, $name /= URI
$parameters /= [1* any]
$type /= certificate, $type /= token.

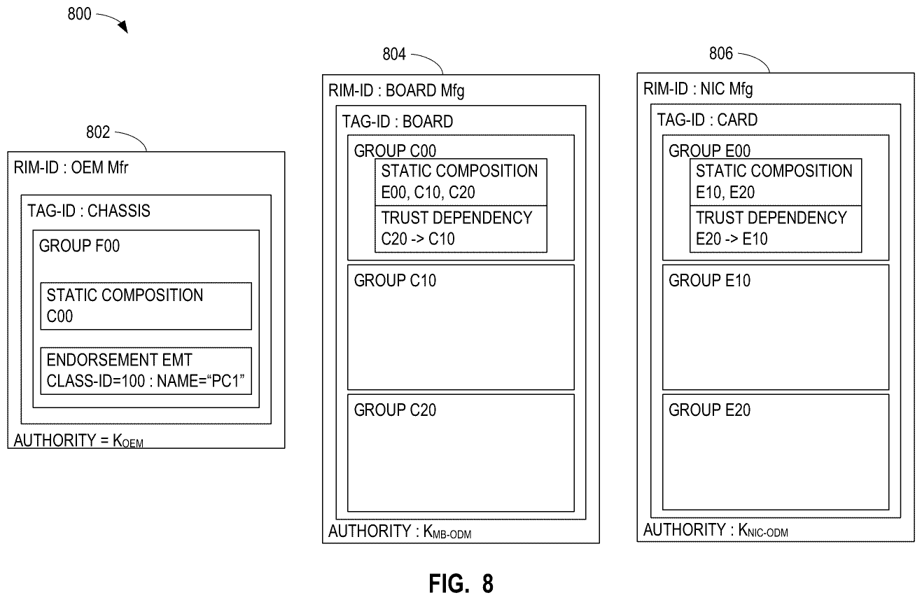

The verifier circuitry 106 generates a network of nodes based on the extracted appraisal contexts. In some examples, each node in the network of nodes corresponds to an appraisal context. The appraisal context provides scoping context, allowing the verifier circuitry 106 to appraise attestation evidence, reference values, and endorsements that correspond to the same appraisal context together. In some examples, the verifier circuitry 106 generates an accepted claims set (ACS). The ACS is a representation of the operating state of the attester 102 and includes the collection of attestation evidence offered by the attester 102 and accepted by the verifier circuitry 106. Example accepted claim sets are illustrated in FIGS. 8-31. The verifier circuitry 106 evaluates attestation evidence offered by the attester based on endorsements and reference values. If the verifier circuitry 106 accepts the evidence, it adds the evidence to the ACS.

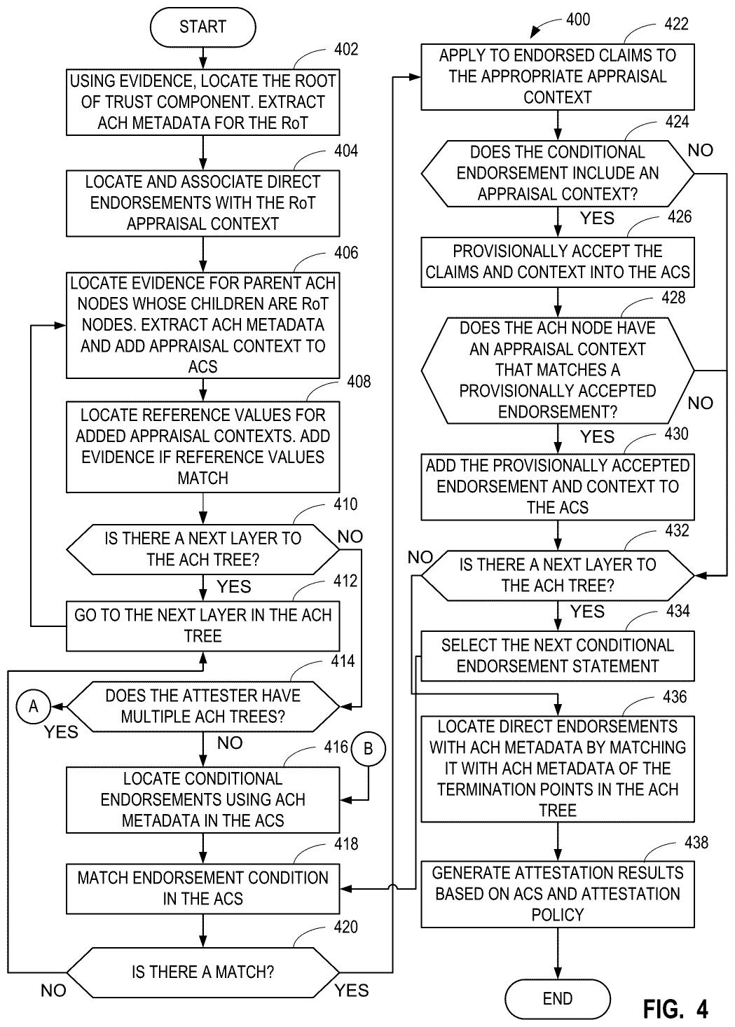

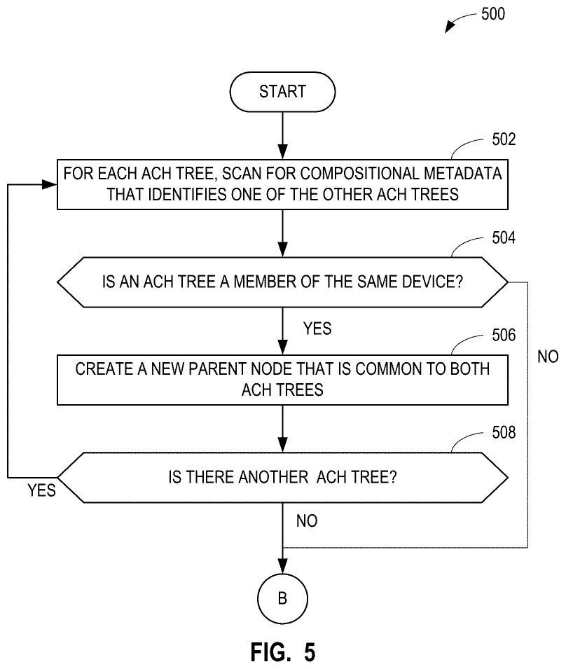

In some examples, the verifier circuitry 106 generates a first network of nodes corresponding to the bottom-up (e.g., a hierarchy that starts from a bottom of a tree or a lowest node) perspective based on evidence, reference values, and direct endorsements, and a second network of nodes corresponding to the top-down (e.g., a hierarchy that starts from a top of a tree or a highest node) perspective based on evidence, reference values, direct endorsements, and conditional endorsements. In some examples, the verifier circuitry 106 combines the first network of nodes and the second network of nodes to create a combined network of nodes, the combined network of nodes aligning the bottom-up and the top-down representations of the attester state by matching common appraisal contexts. In some examples, the verifier circuitry 106 is instantiated by programmable circuitry executing verifier instructions and/or configured to perform operations such as those represented by the flowcharts of FIGS. 4 and 5. In some examples, the verifier circuitry 106 processes attestation evidence, reference values, and endorsements according to rules set by a verifier owner.

The verifier circuitry 106 generates attestation results based on the combined network of nodes and attestation evidence appraisal policies and causes the attestation results to be sent to the relying party 104. In some examples, the entire ACS, a subset of the ACS, and/or a boolean yes/no attestation result for the attester 102 is generated by the verifier circuitry 106.

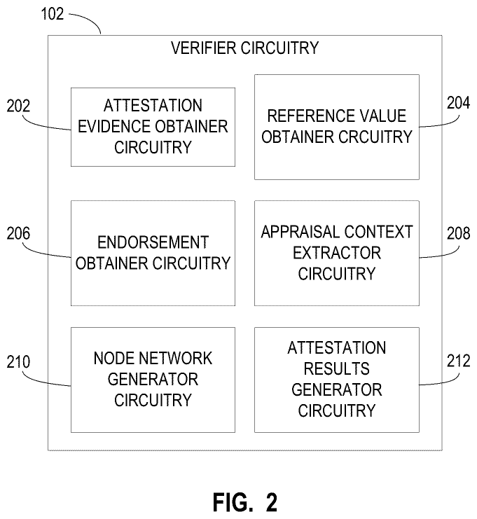

FIG. 2 is a block diagram of an example implementation of the verifier circuitry 106 of FIG. 1 to do generate attestation results. The verifier circuitry 106 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the verifier circuitry 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The example verifier circuitry 106 of the illustrated example of FIG. 2 includes an example attestation evidence obtainer circuitry 202, an example reference value obtainer circuitry 204, an example endorsement obtainer circuitry 206, an example appraisal context extractor circuitry 208, an example node network generator circuitry 210, and an example attestation results generator circuitry 212.

The example attestation evidence obtainer circuitry 202 of the illustrated example of FIG. 2 obtains attestation evidence from the attester 102. In some examples, the attestation evidence obtainer circuitry 202 requests attestation evidence from the attester 102. The attestation evidence obtainer circuitry 202 sends the attestation evidence to the appraisal context extractor circuitry 208. In some examples, the attestation evidence obtainer circuitry 202 sends the attestation evidence to the node network generator circuitry 210. In some examples, the attestation evidence obtainer circuitry 202 identifies a format of the attestation evidence and includes the identified format with the attestation evidence. In some examples, the evidence obtainer circuitry 202 is instantiated by programmable circuitry executing evidence obtainer instructions and/or configured to perform operations such as those represented by the flowchart of FIG. 4.

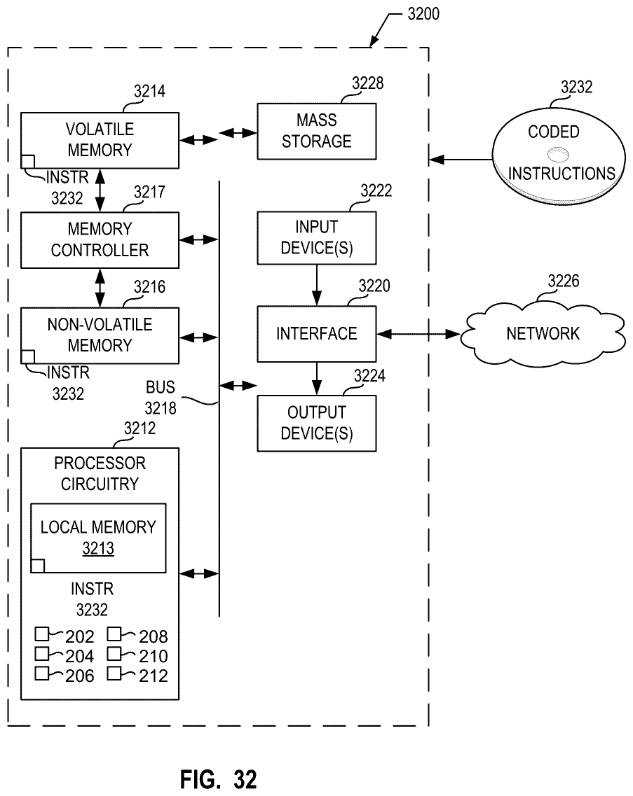

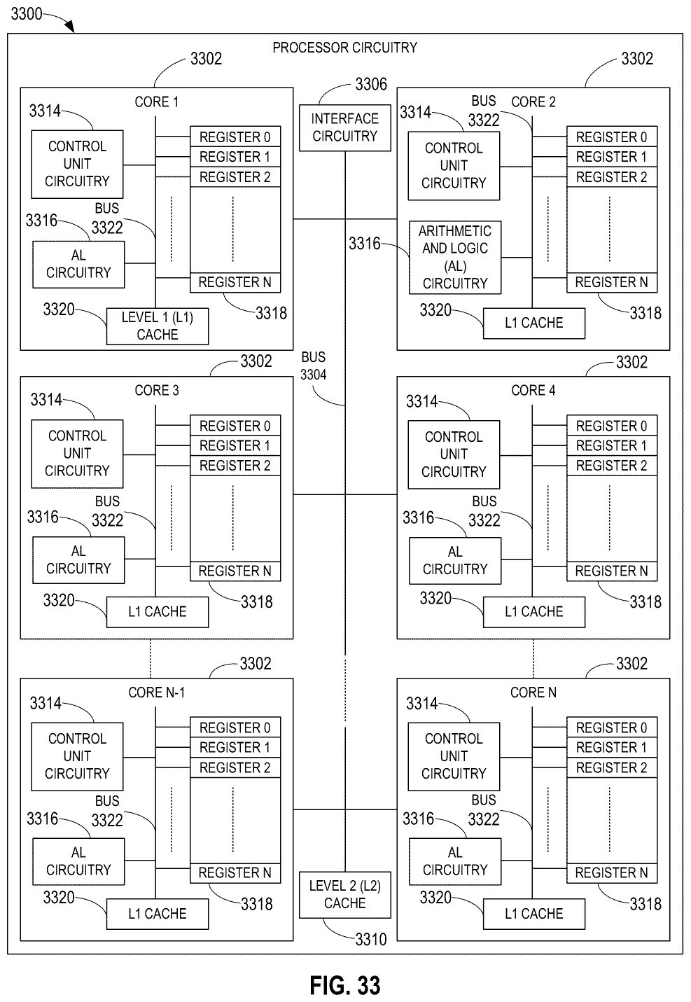

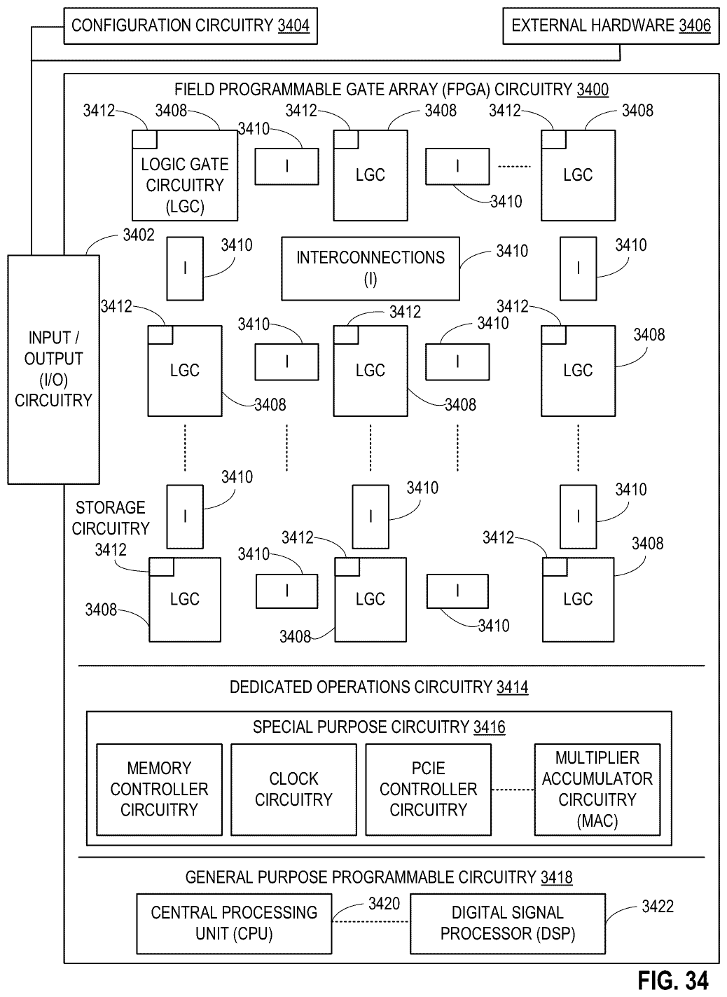

In some examples, the verifier circuitry 106 includes means for obtaining attestation evidence from an attester 102. For example, the means for obtaining may be implemented by attestation evidence obtainer 202. In some examples, the attestation evidence obtainer 202 may be instantiated by programmable circuitry such as the example programmable circuitry 3212 of FIG. 32. For instance, the attestation evidence obtainer 202 may be instantiated by the example microprocessor 3300 of FIG. 33 executing machine executable instructions such as those implemented by at least block 406 of FIG. 4. In some examples, the attestation evidence obtainer 202 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the attestation evidence obtainer 202 may be instantiated by any other combination of hardware, software, and/or firmware. For example, the attestation evidence obtainer 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example reference value obtainer circuitry 204 of the illustrated example of FIG. 2 obtains reference values from a reference value provider. The reference value obtainer circuitry 204 sends the reference values to the appraisal context extractor circuitry 208. In some examples, the reference value obtainer circuitry 204 sends the reference values to the node network generator circuitry 210. In some examples, the reference value obtainer circuitry 204 identifies a format of the reference values and includes the identified format with the reference values. In some examples, the reference value obtainer circuitry 204 instantiated by programmable circuitry executing reference value obtainer instructions and/or configured to perform operations such as those represented by the flowchart of FIG. 4.

In some examples, the verifier circuitry 106 includes means for obtaining reference values from a reference value provider. For example, the means for obtaining may be implemented by reference value obtainer circuitry 204. In some examples, the reference value obtainer circuitry 204 may be instantiated by programmable circuitry such as the example programmable circuitry 3212 of FIG. 32. For instance, the reference value obtainer circuitry 204 may be instantiated by the example microprocessor 3300 of FIG. 33 executing machine executable instructions such as those implemented by at least block 408 of FIG. 4. In some examples, the reference value obtainer circuitry 204 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the reference value obtainer circuitry 204 may be instantiated by any other combination of hardware, software, and/or firmware. For example, the reference value obtainer circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example endorsement obtainer circuitry 206 of the illustrated example of FIG. 2 obtains endorsements from an endorser. The endorsement obtainer circuitry 206 sends the endorsements to the appraisal context extractor circuitry 208. In some examples, the endorsement obtainer circuitry 206 sends the endorsements to the node network generator circuitry 210. In some examples, the endorsement obtainer circuitry 206 identifies a format of the endorsements and includes the identified format with the reference values. In some examples, the endorsement obtainer circuitry 206 identifies the type of endorsement (e.g., a direct endorsement or a conditional endorsement) and includes the identified type with the endorsement. In some examples, the endorsement obtainer circuitry 206 is instantiated by programmable circuitry executing endorsement obtainer instructions and/or configured to perform operations such as those represented by the flowchart of FIG. 4.

In some examples, the verifier circuitry 106 includes means for obtaining endorsements from an endorser. For example, the means for obtaining may be implemented by endorsement obtainer circuitry 206. In some examples, the endorsement obtainer circuitry 206 may be instantiated by programmable circuitry such as the example programmable circuitry 3212 of FIG. 32. For instance, the endorsement obtainer circuitry 206 may be instantiated by the example microprocessor 3300 of FIG. 33 executing machine executable instructions such as those implemented by at least blocks 404, 416, and 436 of FIG. 4. In some examples, the endorsement obtainer circuitry 206 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the endorsement obtainer circuitry 206 may be instantiated by any other combination of hardware, software, and/or firmware. For example, the endorsement obtainer circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example appraisal context extractor circuitry 208 of the illustrated example of FIG. 2 extracts appraisal context information from attestation evidence, reference values, and endorsements. For example, a supplier may maintain an ontology, taxonomy, or database of components where a hierarchy of components may be represented such that a sub-component may be known to exist within its parent component. The supplier may assert endorsements including a component identifier (e.g., an OID) relevant to the endorsement. In that example, the appraisal context extractor circuitry 208 identifies the OID and records the OID for use in generation of appraisal context metadata. The appraisal context metadata is used in generation of a network of nodes. In some examples, the appraisal context extractor circuitry 208 sends the extracted metadata to the node network generator circuitry 210. In some examples, the appraisal context extractor circuitry 208 is instantiated by programmable circuitry executing appraisal context extractor instructions and/or configured to perform operations such as those represented by the flowchart of FIG. 4.

In some examples, the verifier circuitry 106 includes means for extracting appraisal context metadata from attestation evidence, reference values, and endorsements. For example, the means for extracting may be implemented by appraisal context extractor circuitry 208. In some examples, the appraisal context extractor circuitry 208 may be instantiated by programmable circuitry such as the example programmable circuitry 3212 of FIG. 32. For instance, the appraisal context extractor circuitry 208 may be instantiated by the example microprocessor 3300 of FIG. 33 executing machine executable instructions such as those implemented by at least blocks 402, 406 of FIG. 4. In some examples, the appraisal context extractor circuitry 208 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the appraisal context extractor circuitry 208 may be instantiated by any other combination of hardware, software, and/or firmware. For example, the appraisal context extractor circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example node network generator circuitry 210 of the illustrated example of FIG. 2 generates a network of nodes based on appraisal contexts. In some examples, each node in the network of nodes corresponds to an appraisal context. The appraisal context provides scoping context, allowing the node network generator circuitry 210 to appraise evidence, reference values, and endorsements that correspond to the same appraisal context together. In some examples, the node network generator circuitry generates an ACS for the attester. The node network generator circuitry 210 evaluates evidence offered by the attester based on endorsements and reference values. If the node network generator circuitry 210 accepts the evidence, it adds the claims in the evidence to the ACS.

In some examples, the node network generator circuitry 210 generates a first network of nodes from the bottom-up perspective and a second network of nodes from the top-down perspective. In some examples, the node network generator circuitry 210 combines the first network of nodes and the second network of nodes to create a combined network of nodes, the combined network of nodes aligning the bottom-up and the top-down representations of the attester state by matching common appraisal contexts.

In some examples, the node network generator circuitry 210 begins by building the first network of nodes, corresponding to the bottom-up perspective. In some examples, the node network generator circuitry 210 locates a direct endorsement of an attester root-of-trust node. The node network generator circuitry 210 compares attestation evidence from the root-of-trust node, the attestation evidence about the parent node(s) of the root-of-trust node, to reference values corresponding to the parent node(s)—that is reference values with the same appraisal context as the attestation evidence. The node network generator circuitry 210 accepts claims about the parent node(s) if the comparison satisfies the node network generator circuitry 210. The node network generator circuitry 210 repeats this process for further parent nodes throughout the network of nodes, until a terminal node (e.g., a node with no parent nodes) is reached. In some examples, the node network generator circuitry 210 locates multiple root-of trust nodes and generates a different network of nodes for each root of trust. In some examples, the node network generator circuitry 210 combines the networks of nodes for the roots of trust when an appraisal context is common across the various nodes of the networks. In some examples, the node network generator circuitry 210 determines different networks of nodes for different roots of trust belong to the same device based on appraisal context metadata from both networks and creates a parent node to combine the two (or more) otherwise disparate networks of nodes.

In some examples, the node network generator circuitry 210 generates the second network of nodes, corresponding to the top-down perspective. In some examples, the node network generator circuitry 210 locates a conditional endorsement using appraisal context metadata. In some examples, the node network generator circuitry 210 matches the condition for the conditional endorsement with accepted claims in the first network of nodes and accepts the endorsed claims for the appropriate node. In some examples, if the appraisal context for the endorsed claims does not match an appraisal context included in the network of nodes, the node network generator circuitry 210 provisionally accepts the claims into the ACS by creating a provisional node in the network. In some examples, the node network generator circuitry 210 processes conditional endorsements for the parent nodes of the network of nodes until a terminal node is reached. In some examples, if the appraisal context of a provisional node in the network matches the appraisal context of a parent node, the node network generator circuitry 210 adds the endorsement to the appraisal context and adds the endorsement to the ACS. In some examples, the node network generator circuitry 210 locates direct endorsements with appraisal context metadata matching the appraisal context of the terminal node(s) and adds the direct endorsements to the ACS. In some examples, the node network generator circuitry 210 is instantiated by programmable circuitry executing node network generator instructions and/or configured to perform operations such as those represented by the flowcharts of FIGS. 4 and 5.

In some examples, the verifier circuitry 106 includes means for generating a network of nodes based on appraisal contexts. For example, the means for generating may be implemented by node network generator circuitry 210. In some examples, the node network generator circuitry 210 may be instantiated by programmable circuitry such as the example programmable circuitry 3212 of FIG. 32. For instance, the node network generator circuitry 210 may be instantiated by the example microprocessor 3300 of FIG. 33 executing machine executable instructions such as those implemented by at least blocks 402, 406, 410, 412, 414, 418, 420, 422, 424, 426, 428, 430, 432, 434, and 436 of FIG. 4 and blocks 502, 504, 506, and 508 of FIG. 5. In some examples, the node network generator circuitry 210 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the node network generator circuitry 210 may be instantiated by any other combination of hardware, software, and/or firmware. For example, the node network generator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example attestation results generator circuitry 212 of the illustrated example of FIG. 2 generates attestation results based on a network of nodes and attestation evidence appraisal policies. In some examples, attestation results generator circuitry 212 causes the attestation results to be sent to the relying party 104. In some examples, the attestation results generator circuitry 212 sends the entire ACS to the relying party 104. In other examples, the attestation results generator circuitry 212 generates the attestation results from a subset of the ACS based on an appraisal policy of the relying party 104. For example, the relying party 104 may have an appraisal policy that states the relying party 104 is only interested in information about appraisal contexts corresponding to a particular network interface card on the attester device. In such a case, the attestation results generator circuitry 210 generates attestation results including only the accepted claims related to those appraisal contexts. In some examples, the attestation results generator circuitry 212 outputs a boolean yes/no attestation result for the attester based on the ACS and the appraisal policy. In some examples, the attestation results generator circuitry 212 is instantiated by programmable circuitry executing attestation results generator instructions and/or configured to perform operations such as those represented by the flowchart of FIG. 4.

In some examples, the verifier circuitry 106 includes means for generating attestation results based on a network of nodes and attestation evidence appraisal policies. For example, the means for generating may be implemented by attestation results generator circuitry 212. In some examples, the attestation results generator circuitry 212 may be instantiated by programmable circuitry such as the example programmable circuitry 3212 of FIG. 32. For instance, the attestation results generator circuitry 212 may be instantiated by the example microprocessor 3300 of FIG. 33 executing machine executable instructions such as those implemented by at least block 438 of FIG. 4. In some examples, the attestation results generator circuitry 212 may be instantiated by hardware logic circuitry, which may be implemented by an ASIC, XPU, or the FPGA circuitry 3400 of FIG. 34 configured and/or structured to perform operations corresponding to the machine readable instructions. Additionally or alternatively, the attestation results generator circuitry 212 may be instantiated by any other combination of hardware, software, and/or firmware. For example, the attestation results generator circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the verifier circuitry 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example attestation evidence obtainer circuitry 202, the example reference value obtainer circuitry 204, the example endorsement obtainer circuitry 206, the example appraisal context extractor circuitry 208, the example node network generator circuitry 210, the example attestation results generator circuitry 212, and/or, more generally, the example verifier circuitry 106 of FIG. 2, may be implemented by hardware alone or by hardware in combination with software and/or firmware. Thus, for example, any of the example attestation evidence obtainer circuitry 202, the example reference value obtainer circuitry 204, the example endorsement obtainer circuitry 206, the example appraisal context extractor circuitry 208, the example node network generator circuitry 210, the example attestation results generator circuitry 212, and/or, more generally, the example verifier circuitry 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example verifier circuitry 106 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the verifier circuitry 106 of FIG. 2 and/or representative of example operations which may be performed by programmable circuitry to implement and/or instantiate the verifier circuitry 106 of FIG. 2, are shown in FIGS. 4 and 5. The machine readable instructions may be one or more executable programs or portion(s) of one or more executable programs for execution by programmable circuitry such as the programmable circuitry 3212 shown in the example processor platform 3200 discussed below in connection with FIG. 32 and/or may be one or more function(s) or portion(s) of functions to be performed by the example programmable circuitry (e.g., an FPGA) discussed below in connection with FIGS. 33 and/or 34. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4 and 5, many other methods of implementing the example verifier circuitry 106 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable, and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

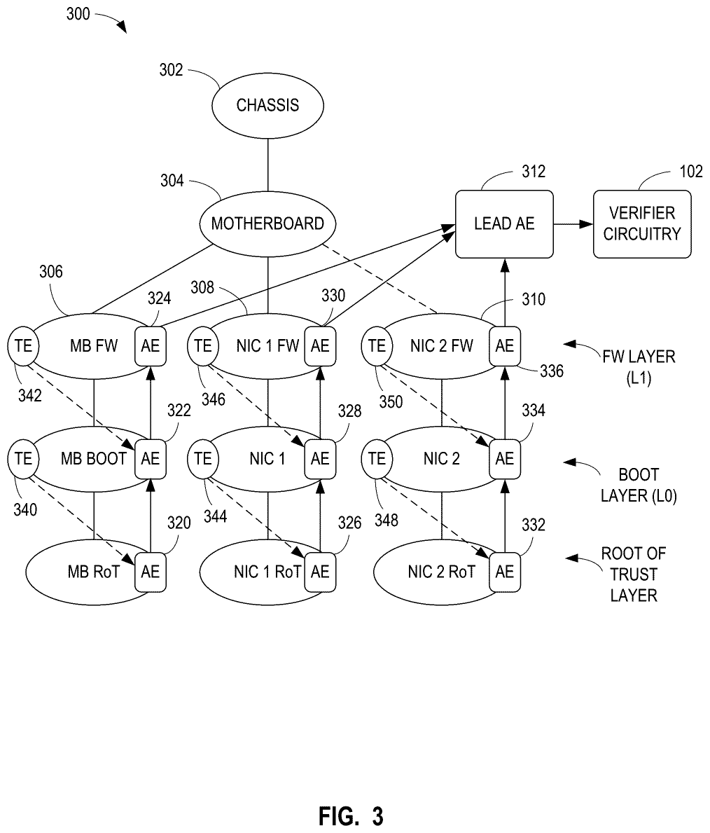

FIG. 3 is a conceptual diagram illustrating an example attester system 300. The example attester system 300 includes an example chassis 302, an example motherboard 304, an example motherboard (MB) firmware 306, an example statically bound network interface card (NIC) 308, a dynamically attached/hot-plug NIC 310, and example lead AE 312. Each of the MB firmware, and the individual NICs consist of three DICE-based layered components: a root of trust, a boot layer (e.g., layer 0), and a firmware layer (e.g., layer 1). In the illustrated example of FIG. 3, the example attester system 300 includes an example first attesting environment 320, an example second attesting environment 322, an example third attesting environment 324, an example fourth attesting environment 326, an example fifth attesting environment 328, an example sixth attesting environment 330, an example seventh attesting environment 332, an example eighth attesting environment 334, and an example ninth attesting environment 336. Attesting environments measure a target environment (TE)—that is, another component of the device. The example attester system includes an example first target environment 340, an example second target environment 342, an example third target environment 344, an example fourth target environment 346, an example fifth target environment 348, and an example sixth target environment 350. An attesting environment of the example attester system 300 measures a target environment, signs the measurement, and sends the signed measurement to a verifier. For example, the example first attesting environment 320 measures the example first target environment, signs the measurement, and sends the signed measurement to the verifier.

In some examples, a collection of target environments are grouped such that the resulting measurements are bundled and signed. For example, the example fifth attesting environment 328 is an embedded CA that issues a certificate containing evidence about the example fourth target environment 346. The signed bundle implicitly defines the appraisal context of the attestation evidence. The example attester system 300 includes an example first appraisal context 350, an example second appraisal context 352, an example third appraisal context 354, an example fourth appraisal context 356, an example fifth appraisal context 358, an example sixth appraisal context 360, an example seventh appraisal context 362, an example eighth appraisal context 364, and an example ninth appraisal context 366. In some examples, the implementation of the attester system assigns appraisal context names (ACN) (e.g., UUID, OID, URI) for some or all of the example appraisal contexts, defines appraisal context parameters (e.g., a range of m of n possible contexts), and or relies on the certificate as an implied context. In some examples, the components of an attester system may be instrumented with appraisal context metadata. Appraisal context metadata explicitly describes DICE layering semantics, trust dependency semantics, and/or semantic that can be inferred from the DICE certificate chain and various other data structures that are implementation dependent. In some examples, multiple appraisal contexts link to multiple parent appraisal contexts and a single appraisal context can link to multiple parent appraisal contexts. In the illustrated example of FIG. 3, appraisal context dependencies are represented as evidence flow lines from an attesting environment of one appraisal context to an attesting environment of another appraisal context. For example, the example second appraisal context 352 is a parent of the example first appraisal context 350, shown by the evidence flow line connecting the example first attesting environment 320 and the example second attesting environment 322.

FIG. 4 is a flowchart representative of example machine readable instructions and/or example operations 400 that may be executed, instantiated, and/or performed by programmable circuitry to generate attestation results for a relying party. The example machine-readable instructions and/or the example operations 400 of FIG. 4 begin at block 402, at which the appraisal context extractor circuitry 208 extracts ACH metadata for root of trust components of the attester 102. At block 404, the endorsement obtainer circuitry 206 locates and associates direct endorsements with the root of trust appraisal contexts. The node generator circuitry 210 adds the endorsements to a working set (e.g., an accepted claims set (ACS)) representing the state of the attester 102. At block 406, the attestation evidence obtainer circuitry 202 locates evidence for parent nodes of the current nodes, the appraisal context extractor circuitry 208 extracts ACH metadata from the attestation evidence, and the node network generator circuitry 210 adds the attestation evidence and appraisal contexts to an ACS. At block 408, the reference value obtainer circuitry 204 locates reference values for the added appraisal contexts and the node network generator circuitry 210 adds the evidence to the node network at the appropriate appraisal context if the evidence matches the reference values. At block 410 the node network generator circuitry 210 determines whether there is another layer in the network of nodes. If there is (e.g., block 410 returns a result of YES), the node network generator circuitry 210 goes to the next layer in the network (block 412) and returns to block 406. If there is not another layer of the network (e.g., block 410 returns a result of NO), the node network generator circuitry determines whether the attesting device 104 has multiple networks of nodes (block 414). If the attester 102 does have multiple networks of nodes (e.g., block 414 returns a result of YES), the process continues at block 502 of FIG. 5. If the attester 102 does not have multiple networks of nodes (e.g., block 414 returns a result of NO), the endorsement obtainer circuitry 206 locates conditional endorsements using the ACH metadata included in the ACS (block 416). The endorsement obtainer circuitry 206 searches a repository of endorsements for matching appraisal context metadata.

At block 418, the node network generator circuitry 210 matches the endorsement conditions with the attestation information existing in the ACS. At block 420, the node network generator circuitry 210 determines whether there is a match. If there is not a match (e.g., block 418 returns a result of NO), the process returns to block 412. If there is a match (e.g., block 420 returns a result of YES), the node network generator circuitry 210 applies the endorsed claims to the appropriate appraisal context (block 422). At block 424, the appraisal context extractor circuitry 208 determines whether the conditional endorsement included an appraisal context. If the conditional endorsement does not include an appraisal context (e.g., block 424 returns a result of NO), the node network generator circuitry 210 applies the endorsement to the current node and the process proceeds to block 432. If the conditional endorsement does include an appraisal context (e.g., block 424 returns a result of YES), but the appraisal context does not exist in the network of nodes, the node network generator circuitry 210 provisionally accepts the claims and appraisal context into the ACS (block 426). The node network generator circuitry 210 creates a provisional node and assigs it the provisionally accepted appraisal context. If the appraisal context does exist in the network of nodes, the node network generator circuitry adds the endorsement to the corresponding node. At block 428, the node network generator circuitry 210 determines whether the network of nodes has an appraisal context that matches a provisionally accepted endorsement. If the network of nodes does have a matching appraisal context (e.g., block 428 returns a result of YES), the node network generator circuitry adds the provisionally accepted claims and appraisal context to the ACS (block 430). At block 432 the node network generator circuitry 210 determines whether there is another layer in the network of nodes. If there is another layer (e.g., block 432 returns a result of YES), then the node network generator circuitry 210 selects the next conditional endorsement (block 434) and returns to block 418. If there is not another layer (e.g., block 432 returns a result of NO), the endorsement obtainer circuitry 206 locates direct endorsements with ACH metadata matching the termination points in the network of nodes (block 436). At block 438, the attestation results generator circuitry 212 generates attestation results for the relying party 104 based on the ACS and attestation policy. Then, the example process 400 terminates.

FIG. 5 is a flowchart representative of example machine readable instructions and/or example operations 500 that may be executed, instantiated, and/or performed by programmable circuitry to combine multiple networks of nodes of the same attester 102. The example machine-readable instructions and/or the example operations 500 of FIG. 5 begin at block 502, at which the node network generator circuitry 210 scans, for each of the networks of nodes, appraisal context metadata that identifies one of the other networks of nodes. At block 504, the node network generator circuitry 210 determines whether two networks of nodes are part of the same attester 102. If two networks of nodes are determined to be part of the same attester 102 (e.g., block 504 returns a result of YES), the node network generator circuitry 210 creates a new node that is a parent to both of the networks of nodes (block 506). At block 508, the node network generator circuitry 210 determines whether there is another network of nodes. If there is (e.g., block 508 returns a result of YES), the node process returns to block 502. If there is not (e.g., block 508 returns a result of NO), the example process 500 terminates, and example process 400 resumes at block 414.

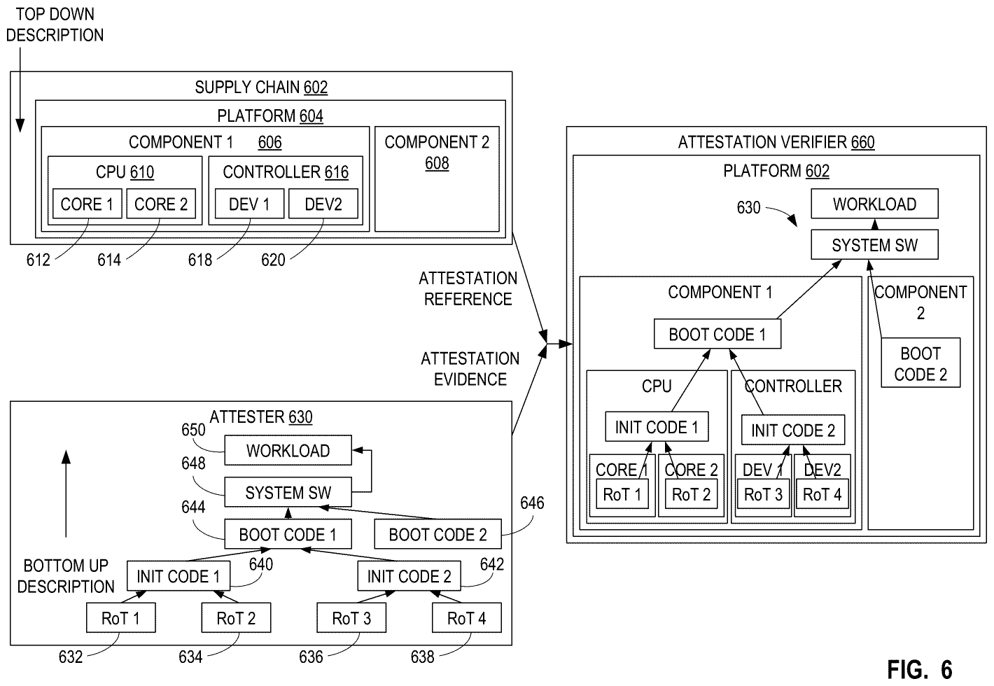

FIG. 6 is a conceptual diagram illustrating a combination of bottom-up and top-down description of another example attester system 600. An example top-down description 602 of the example attester system 600 includes an example platform 604 (e.g., a device platform) consisting of an example first component 606 and an example second component 608. The example first component consists of several sub-components including an example CPU 610 consisting of an example first core 612 and an example second core 614, and an example controller 616 consisting of an example first device 618 and an example second device 620. The example top-down description 602 is observed from the perspective of a system designer (e.g., OEM, VAR). The top-down perspective is typical of a HW Bill of Materials. An example bottom-up description 630 is observed from the perspective of multiple roots of trust. The example bottom-up description 630 includes an example first root of trust 632, an example second root of trust 634, an example third root of trust 636, and an example fourth root of trust 638, an example first init code 640, an example second init code 642, an example first boot code 644, an example second boot code 646, an example system software 648, and an example workload 650. From each root of trust, there is init code that launches boot code, boot code that launches system SW, and system software that launches a workload. The bottom-up perspective is typical of a trusted or secure boot system.

An example attestation verifier 660 aligns the example top-down description 602 with the example bottom-up description 630 to form a detailed representation of the attester system 600. The attestation verifier 660 accepts inputs from both the attester and various supply chain entities to produce a detailed picture of the attester state (which includes trustworthiness properties). The combined state is used to appraise the overall trustworthiness of the attester device. However, aligning the two perspectives correctly can be challenging. Reference value providers create manifests that describe reference values and endorsed values used for attestation from the top-down description 602 of the attester. The attester produces attestation evidence to make claims about the operating state of the attester from the bottom-up description 630 of the attester. In some examples, the attestation verifier 660 aligns the two descriptions by matching reference values and endorsements to attestation evidence based on appraisal context metadata included with the reference values, endorsements, and attestation evidence. The appraisal context metadata can include an ACN, define appraisal context parameters, or rely on attestation evidence appraisal contexts. The attestation verifier 660 aligns the descriptions by generating a first network of nodes for the bottom-up description 630 and generating a second network of nodes for the top-down description 602. In some examples, the attestation verifier 660 compares the first network of nodes to the second network of nodes to identify common nodes based on appraisal context metadata. In some examples, the attestation verifier 650 then combines the first network of nodes and the second network of nodes to generate a combined network of nodes which includes the attestation information from both the top-down description 602 and the bottom-up description 630.

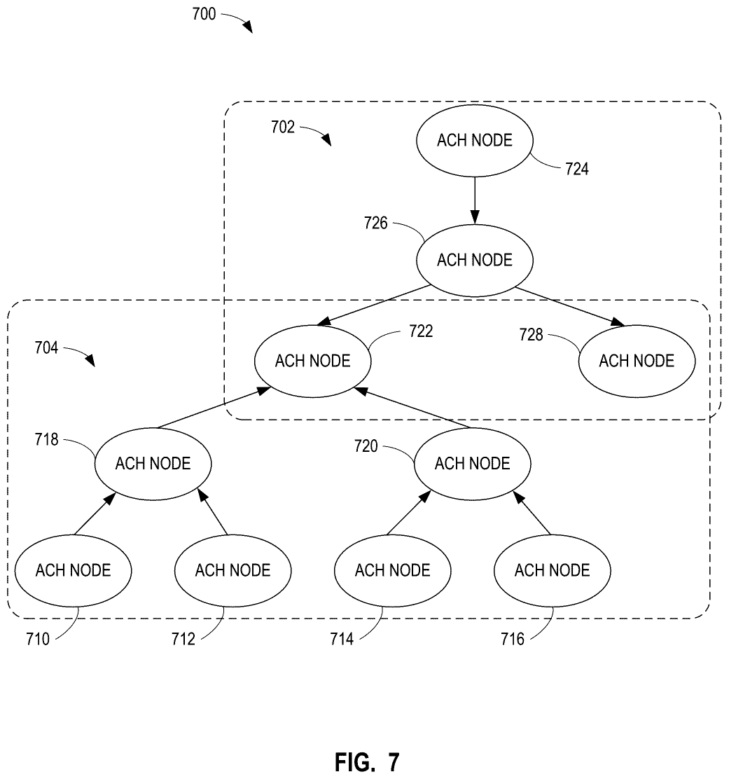

FIG. 7 is a conceptual diagram illustrating an example combined network of nodes 700 generated by the verifier circuitry 106 of FIG. 1. includes a first network of nodes 702 corresponding to a bottom-up description of an attester and a second network of nodes 704 corresponding to a top down-description of the attester. The first network of nodes includes a first root of trust node 710, a second root of trust node 712, a third root of trust node 714, a fourth root of trust node 716, a first intermediate node 718, a second intermediate node 720, and a terminal node 722. Practical limitations prevent the full traversal of the first network of nodes 702 from the root of trust nodes 710-716 to a root node 724 of the attester. Furthermore, there are pragmatic conditions in which the top-down and bottom-up description logics are inconsistent. For example, a device ID certificate that describes an identity key, such as in an enclave, doesn't include the appraisal context. Similarly, the evidence format, such as an SPDM transcript, doesn't include the appraisal context. An attestation manifest, however, may include the appraisal context (as described by ACH Metadata).

The second network of nodes 704 includes the root node 724, an intermediary node 726, the terminal node 722, and a child node 728. The verifier circuitry 106 compares appraisal context metadata from the nodes of the first network of nodes 702 and the nodes of the second network of nodes 704 to identify that the terminal node 722 is a common node of both networks 702, 704. For example, the attestation evidence in the bottom-up description of FIG. 7 might describe the first root of trust node 710 in terms of a digest of software, while the top-down HW Bill of Materials might describe the first root of trust node 710 in terms of a vendor name and device model string. A manifest may be created that relates the digest with the vendor and model information and includes appraisal context information. The verifier circuitry 106 uses the appraisal context information to apply the namespace and scoping limitations that are appropriate. The verifier circuitry 106 combines the first network of nodes 702 and the second network of nodes 704 at terminal node 722 to generate the combined network of nodes 706.

FIG. 8 illustrates example endorsements 800 provided by an endorser for an attester for an example static composition, direct enforcement use case. The endorsements 800 include an example chassis endorsements 802, example motherboard endorsements 804, and an example card endorsements 806. The endorsements 800 include example tags, example groups, example Environment Measurement Tuples (EMTs) (also called Environment Claims), example compositions (static or dynamic), and example trust dependencies. Tags are a grouping construct that contain either a reference (e.g., possible) state or actual (e.g., endorsed) state. Groups are an abstraction for appraisal contexts where claims within a group are evaluated together. EMTs are sets of claims, one claim describing an environment and another claim describing the state of the environment. Trust dependencies describe the AEs trusted with assessing a given TE. Composition is a grouping construct that enumerates the components of a system. Static composition enumerates the system at a time of manufacture, while dynamic composition enumerates the system at a time of attestation.

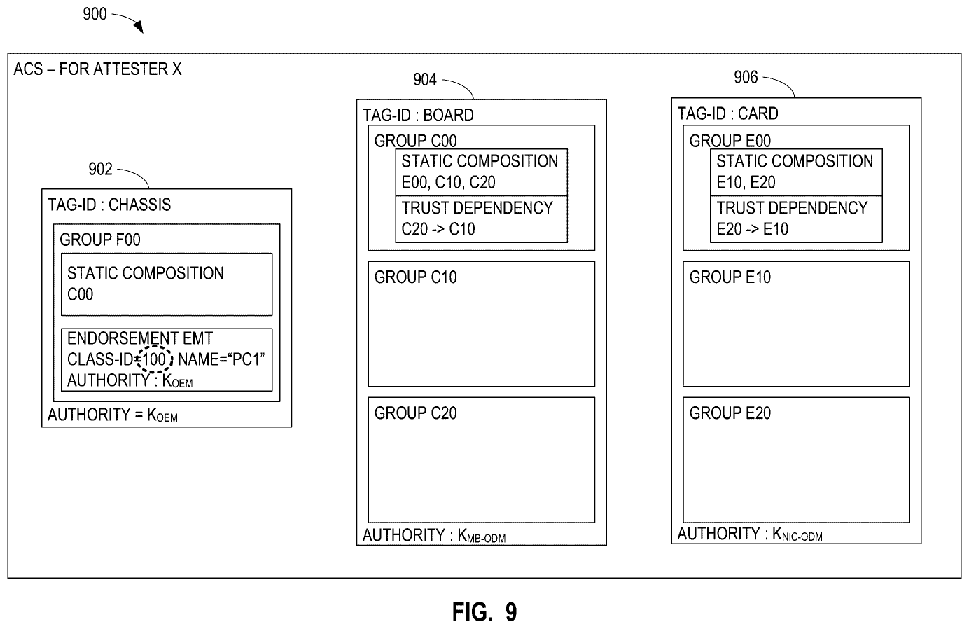

FIG. 9 illustrates an example ACS 900 generated by the verifier circuitry 106 of FIG. 1 for an attester for the example static composition, direct enforcement use case of FIG. 8. The ACS 900 includes an example chassis appraisal context 902, an example motherboard appraisal context 904, and an example NIC appraisal context 906. The example chassis appraisal context 902, the example motherboard appraisal context 904, and the example NIC appraisal context 906 include the example chassis endorsements 802, the example motherboard endorsements 804, and the example card endorsements 806, respectively.

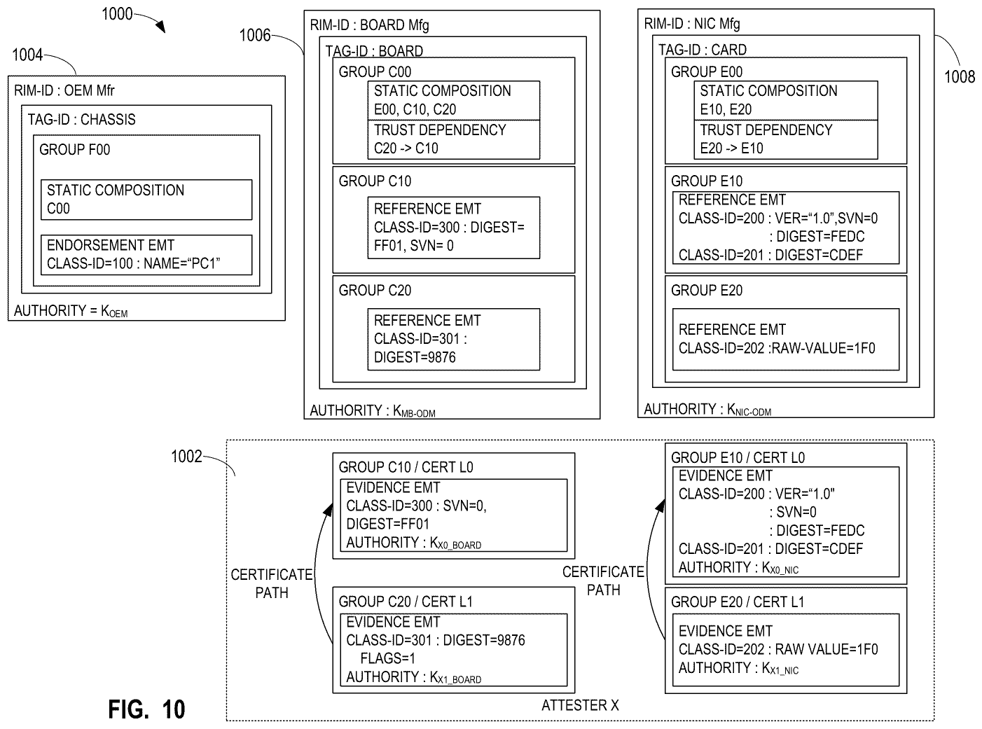

FIG. 10 illustrates example endorsements 1000 provided by an endorser for an attester and example attestation evidence 1002 from the attester for an example evidence matching use case. The endorsements 1000 include an example chassis endorsements 1004, example motherboard endorsements 1006, and an example card endorsements 1008. The example attestation evidence 1002 includes 4 four EMTs describing the state of the attester, each EMT including asserted claims and their associated authority.

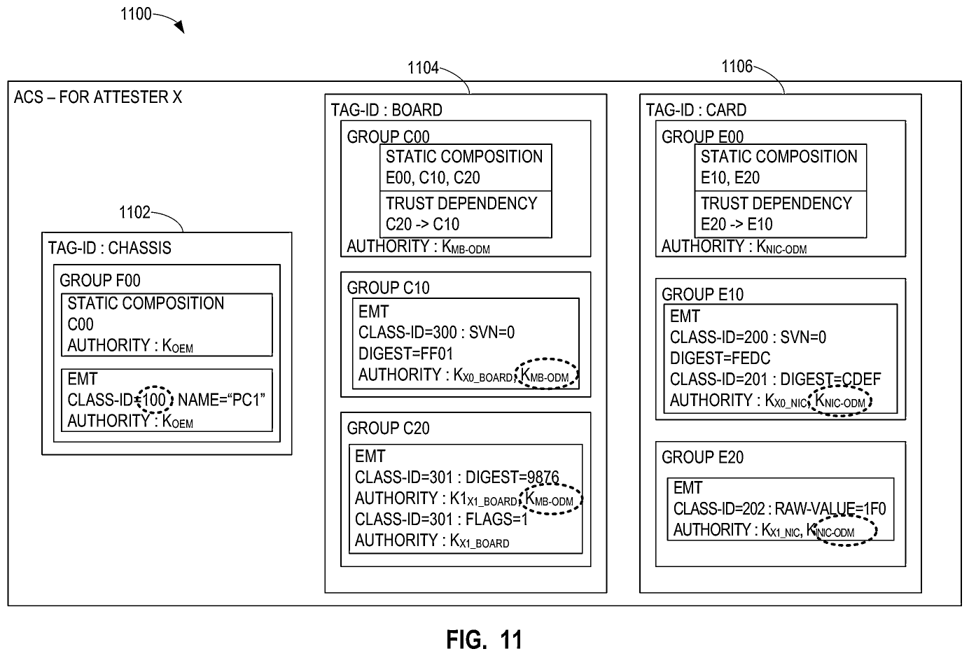

FIG. 11 illustrates an example ACS 1100 generated by the verifier circuitry 106 of FIG. 1 for an attester for the example evidence matching use case of FIG. 10. The ACS 1100 includes an example chassis appraisal context 1102, an example motherboard appraisal context 1104, and an example NIC appraisal context 1106. The verifier circuitry 106 accepts evidence claims under the attester authority. If reference values match accepted claims, then the reverence value provider authority is added to the matching claims.

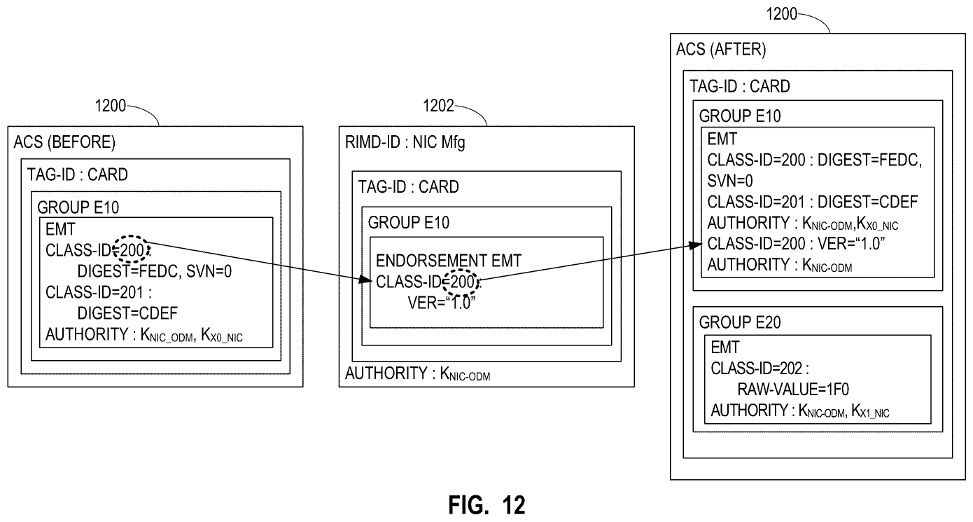

FIG. 12 illustrates an example NIC ACS 1200 generated by the verifier circuitry 106 of FIG. 1 for a NIC of an attester for an example simple endorsement use case. The verifier circuitry 106 matches the claims contained in the NIC ACS 1200 with an endorsement 1202 from a manufacturer of the NIC. The verifier circuitry 106 accepts the endorsed claims in the endorsement 1202 into the NIC ACS 1200.

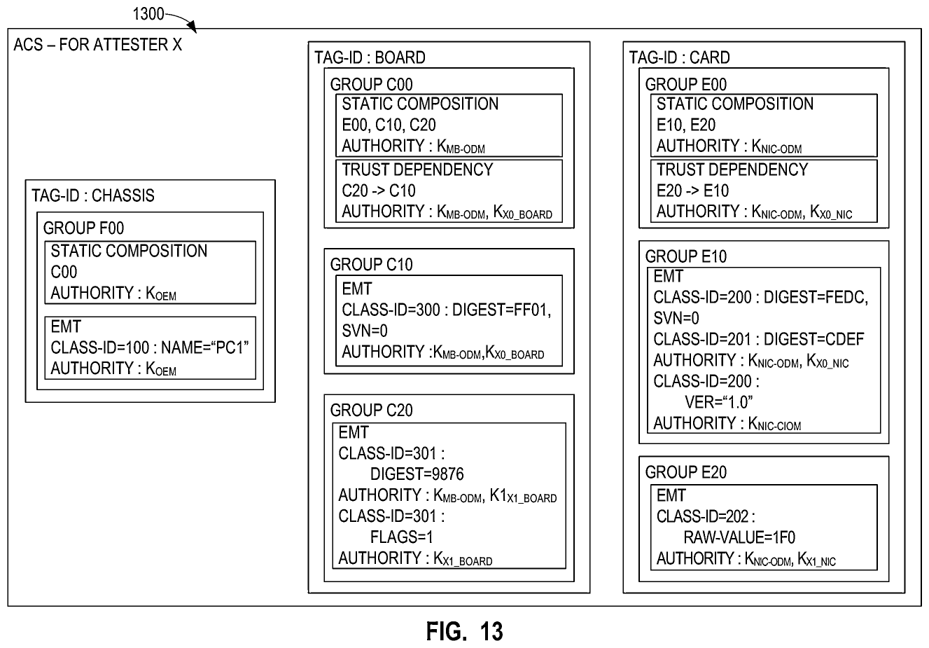

FIG. 13 illustrates an example ACS 1300 generated by the verifier circuitry 106 of FIG. 1 for an attester for the example simple endorsement use case of FIG. 12. The example ACS 1300 is the example ACS 1100 updated with the claims in the endorsement 1202.

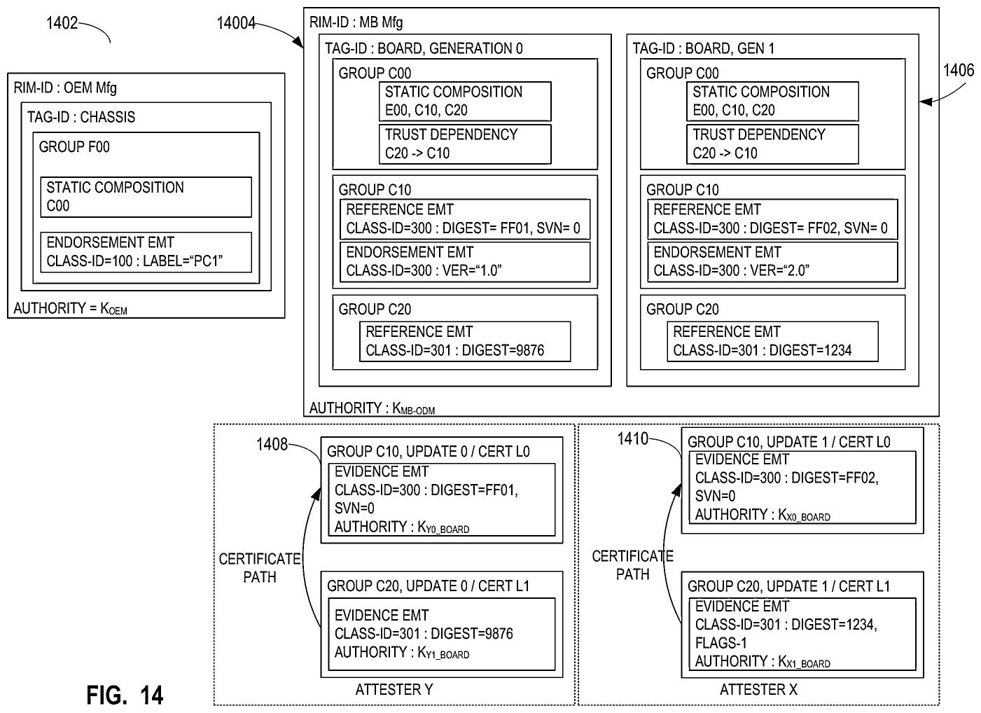

FIG. 14 illustrates example endorsements 1402 from an OEM manufacturer, example endorsements 1404 and reference values 1406 from a motherboard manufacturer, example attestation evidence 1408 from a first attester, and example attestation evidence 1410 from a second attester for an example update and patch use case. The example endorsements 1404 and reference values 1406 from the motherboard manufacturer include a description of a generation zero of the motherboard and a description of a generation one of the motherboard. The example attestation evidence 1408 is for an update zero. The example attestation evidence 1410 is for an update one.

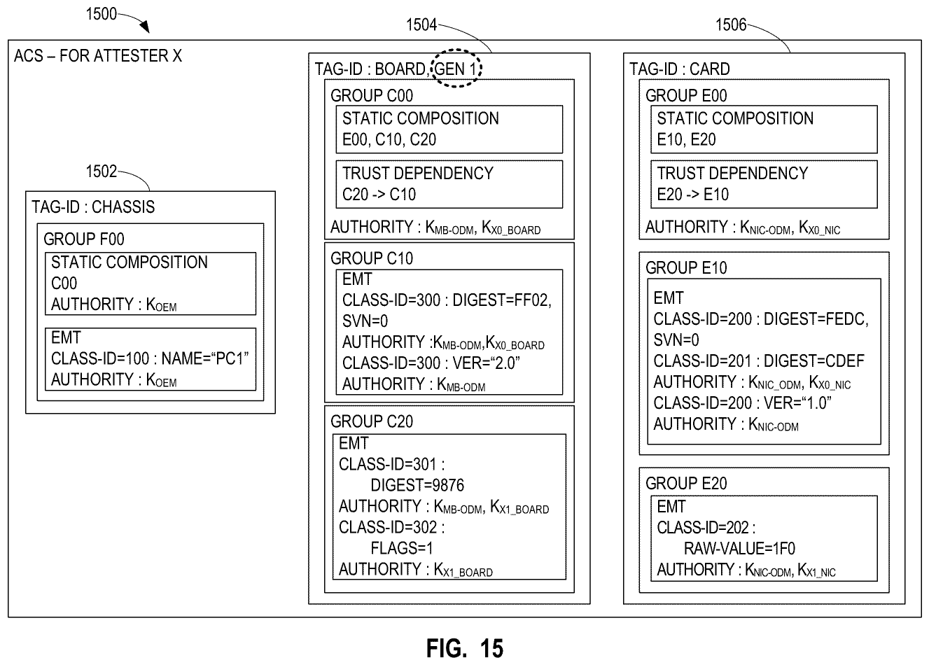

FIG. 15 illustrates an example ACS 1500 generated by the verifier circuitry 106 of FIG. 1 for an attester for the example update and patch use case of FIG. 14. The ACS 1500 includes an example chassis appraisal context 1502, an example motherboard appraisal context 1504, and an example NIC appraisal context 1506. The verifier circuitry 106 ignores the update zero appraisal context because the attestation evidence 1410 for update one matches the endorsement 1404 and reference values 1406 describing the generation one of the motherboard.

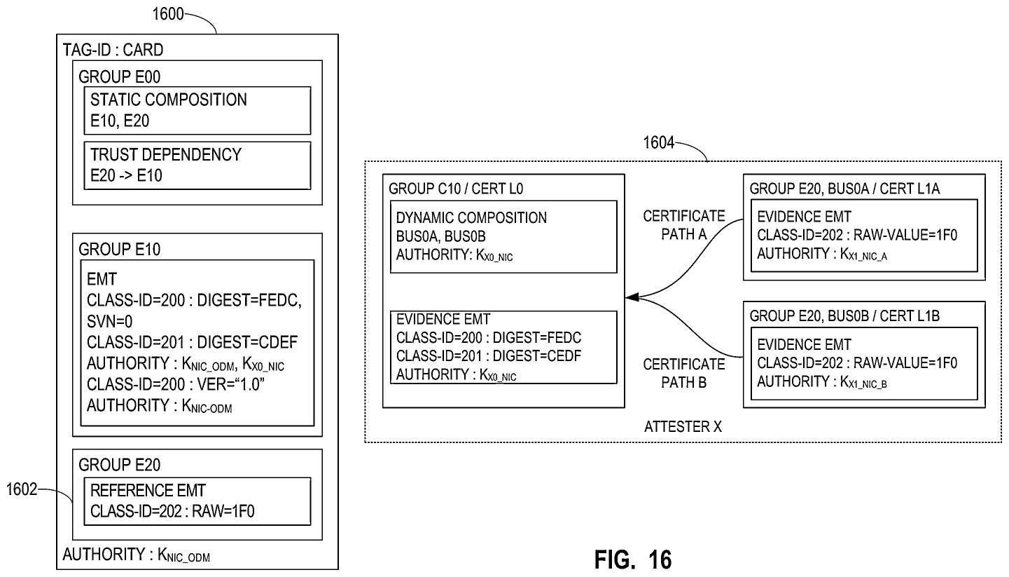

FIG. 16 illustrates example endorsements 1600 and reference values 1602 provided by a NIC manufacturer for a NIC of an attester and attestation evidence 1604 provided by the attester for an example dynamic composition use case.

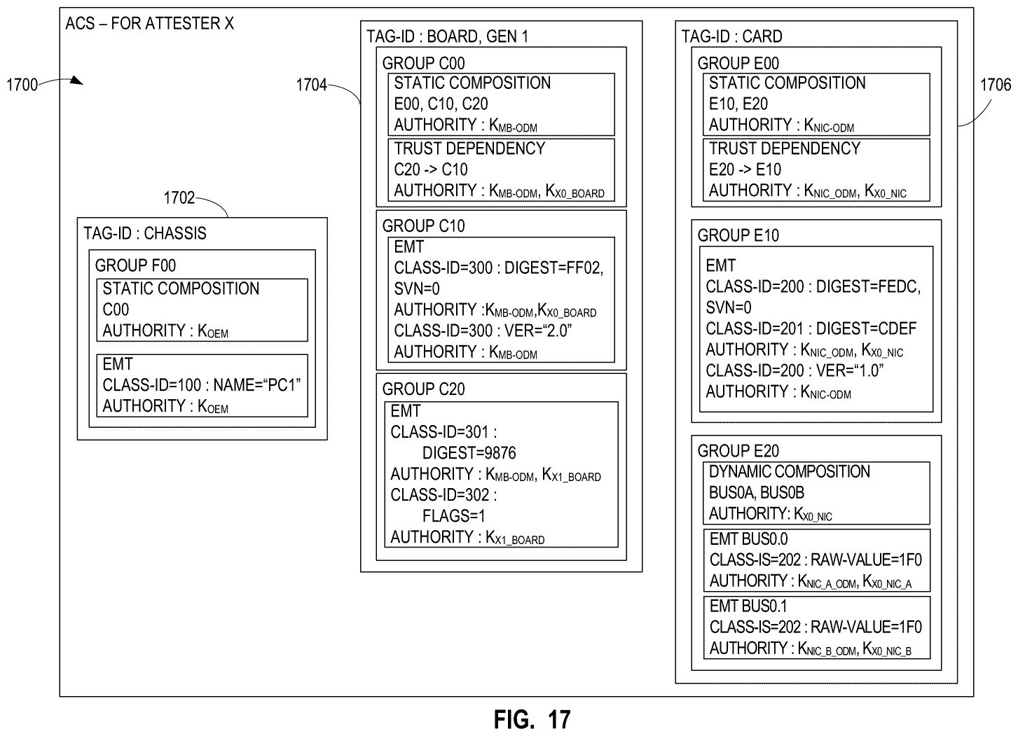

FIG. 17 illustrates an example ACS 1700 generated by the verifier circuitry 106 of FIG. 1 for an attester for the example dynamic composition use case of FIG. 16. The ACS 1700 includes an example chassis appraisal context 1702, an example motherboard appraisal context 1704, and an example NIC appraisal context 1706. The AE discovered multiple TE instances not found in the static composition. The AE generated evidence for each instance and added a dynamic composition state.

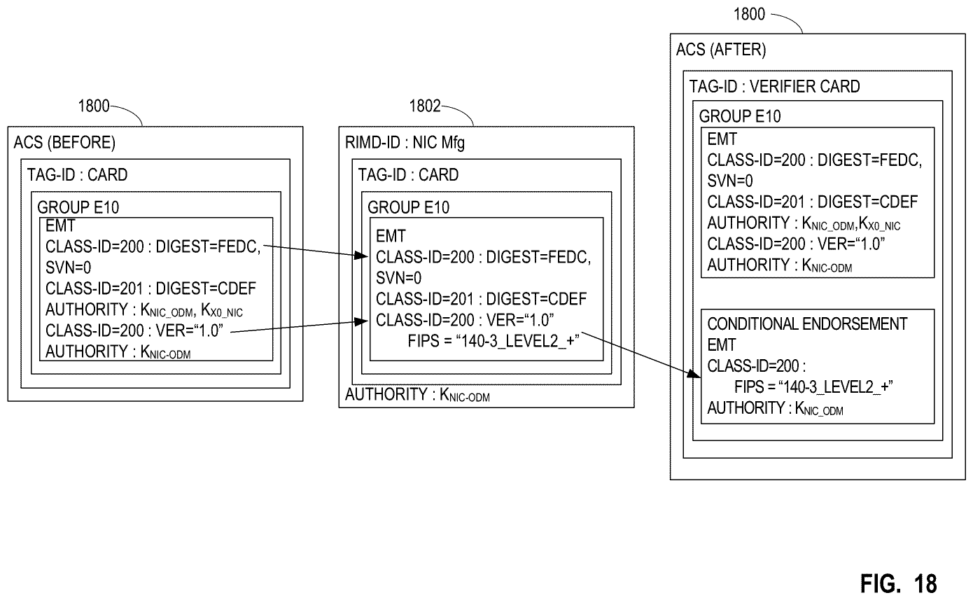

FIG. 18 illustrates an example NIC ACS 1800 generated by the verifier circuitry 106 of FIG. 1 for a NIC of an attester for an example conditional endorsement use case. The verifier circuitry 106 matches the claims contained in the NIC ACS 1800 with a conditional endorsement 1802 from a manufacturer of the NIC. The verifier circuitry 106 accepts the claims in the conditional endorsement 1802 into the NIC ACS 1800 because the NIC ACS 1800 matches the expected state in the conditional endorsement 1802.

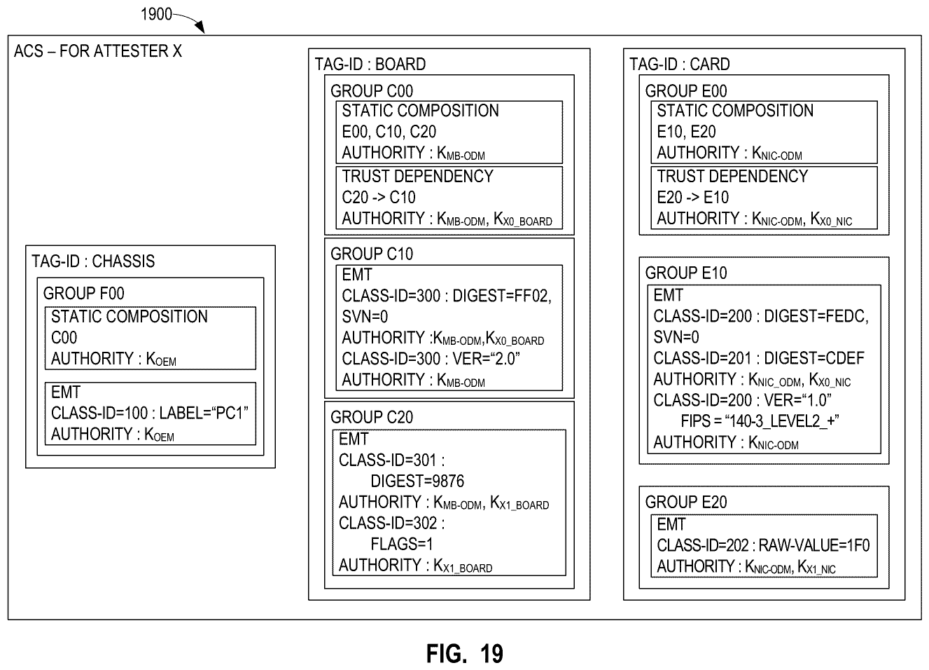

FIG. 19 illustrates an example ACS 1900 generated by the verifier circuitry 106 of FIG. 1 for an attester for the example conditional endorsement use case of FIG. 18. The example ACS 1900 is the example ACS 1700 updated with the claims in the conditional endorsement 1802.

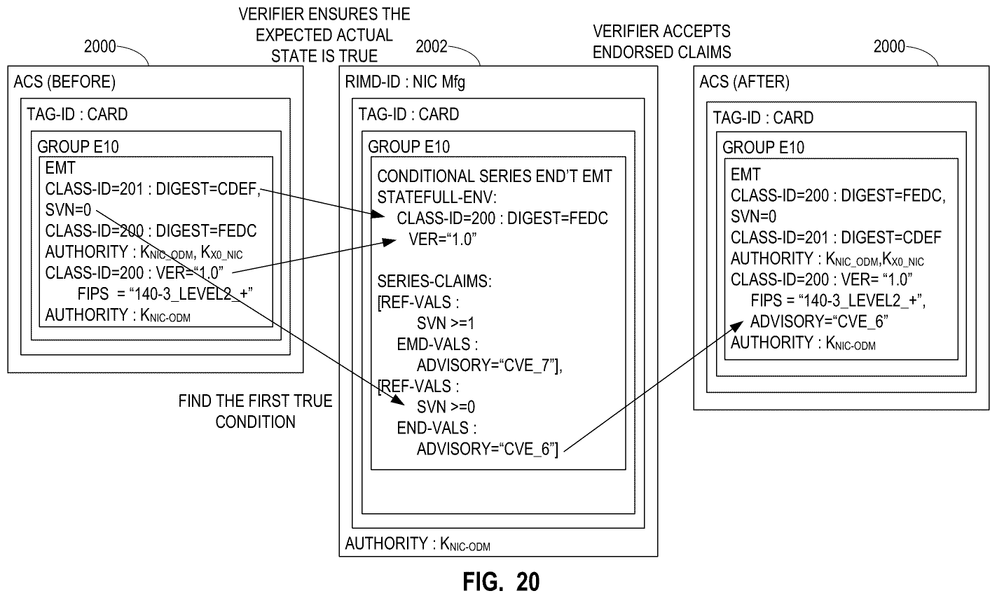

FIG. 20 illustrates an example NIC ACS 2000 generated by the verifier circuitry 106 of FIG. 1 for a NIC of an attester for an example conditional endorsement series use case. The verifier circuitry 106 matches the claims contained in the NIC ACS 2000 with a conditional endorsement series 2002 from a manufacturer of the NIC. The verifier circuitry 106 first confirms the NIC ACS 2000 matches the expected state in the conditional endorsement series 2002. The verifier circuitry 106 accepts the claims in the conditional endorsement series 2002 into the NIC ACS 2000 because a condition in the conditional endorsement series is true.

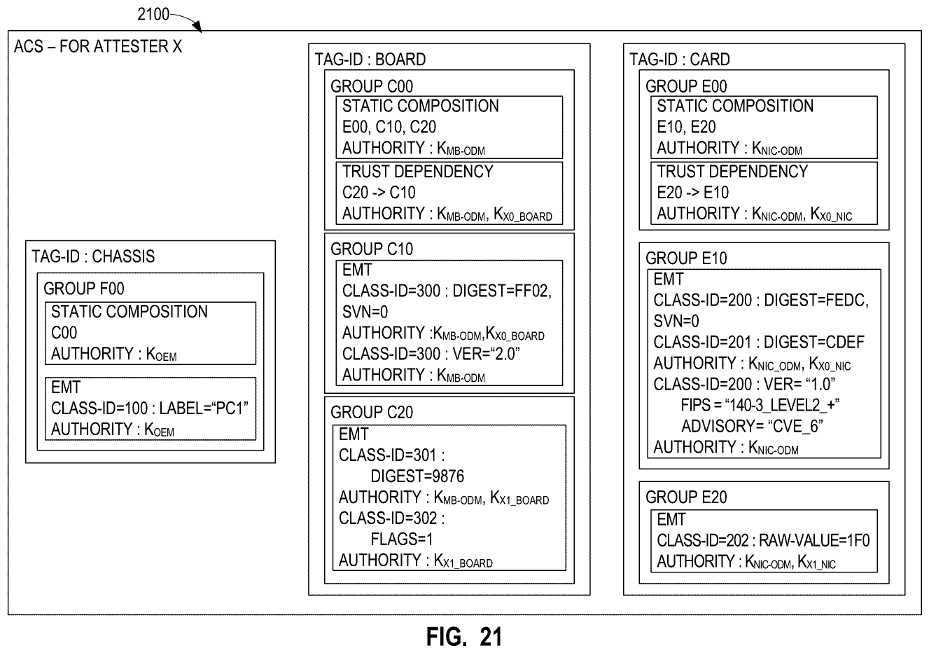

FIG. 21 illustrates an example ACS 2100 generated by the verifier circuitry 106 of FIG. 1 for an attester for the example conditional endorsement series use case of FIG. 20. The example ACS 2100 is the example ACS 1900 updated with the claims in the conditional endorsement series 2002.

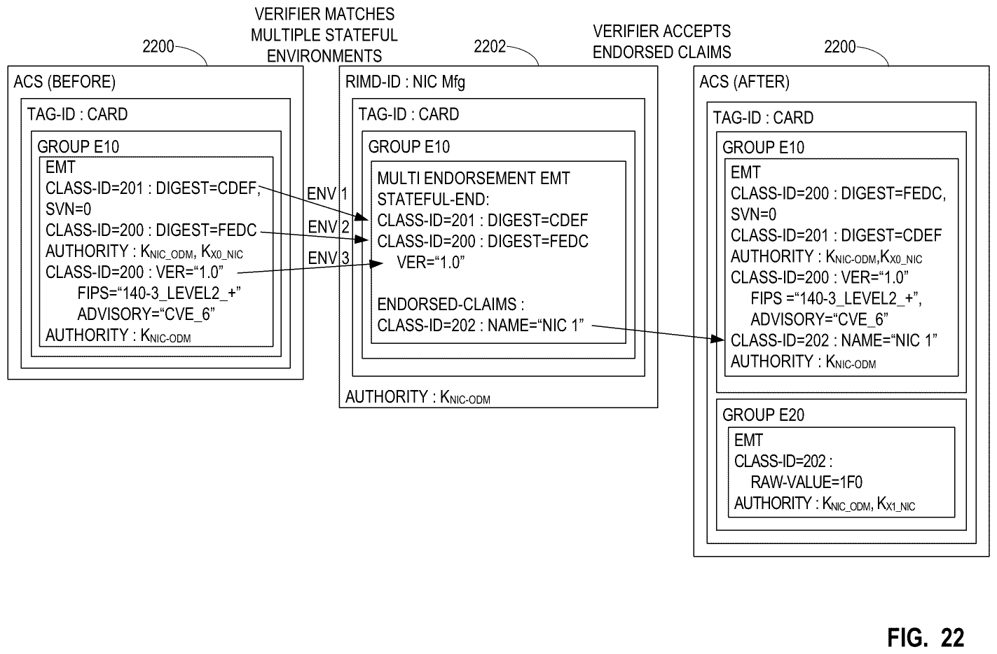

FIG. 22 illustrates an example NIC ACS 2200 generated by the verifier circuitry 106 of FIG. 1 for a NIC of an attester for an example multi-endorsement use case. The verifier circuitry 106 matches multiple environments contained in the NIC ACS 2200 with a multi-endorsement EMT 2202 from a manufacturer of the NIC. The verifier circuitry 106 accepts the claims in the multi-endorsement EMT 2202 into the NIC ACS 2200 because all of the environments match.

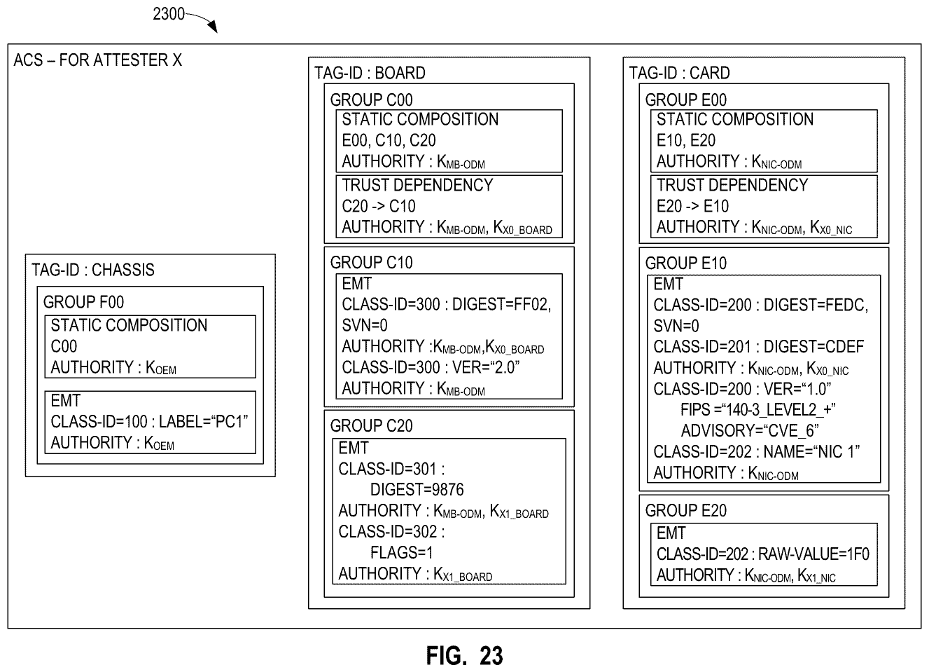

FIG. 23 illustrates an example ACS 2300 generated by the verifier circuitry 106 of FIG. 1 for an attester for the example multi-endorsement use case of FIG. 22. The example ACS 2300 is the example ACS 2100 updated with the claims in the multi-endorsement EMT 2202.

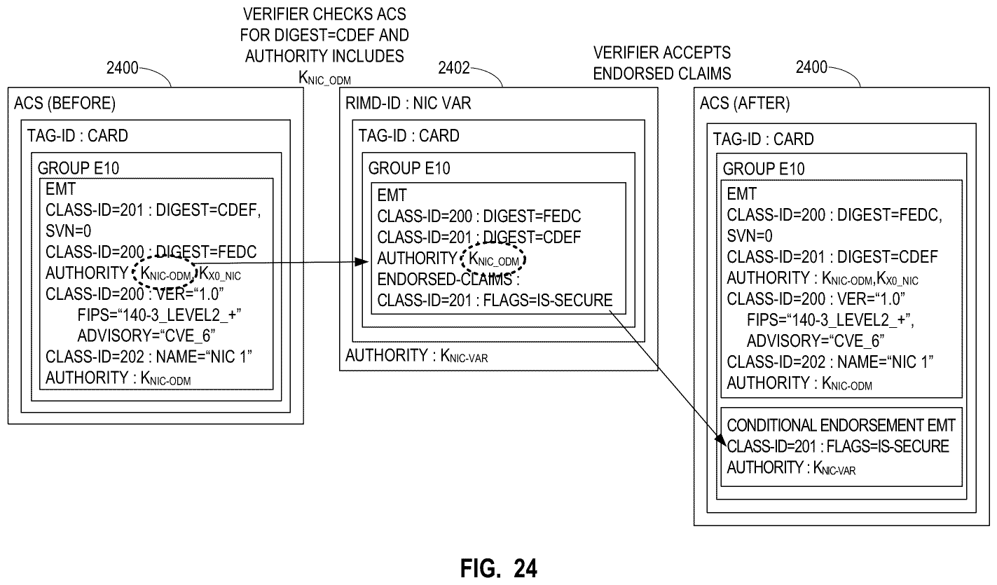

FIG. 24 illustrates an example NIC ACS 2400 generated by the verifier circuitry 106 of FIG. 1 for a NIC of an attester for an example conditional endorsement with authority use case. The verifier circuitry 106 matches environments and authorities contained in the NIC ACS 2400 with environments and authorities contained in a conditional endorsement 2402 from a manufacturer of the NIC. The verifier circuitry 106 accepts the claims in the conditional endorsement 2402 into the NIC ACS 2400 because the environments and the authorities match.

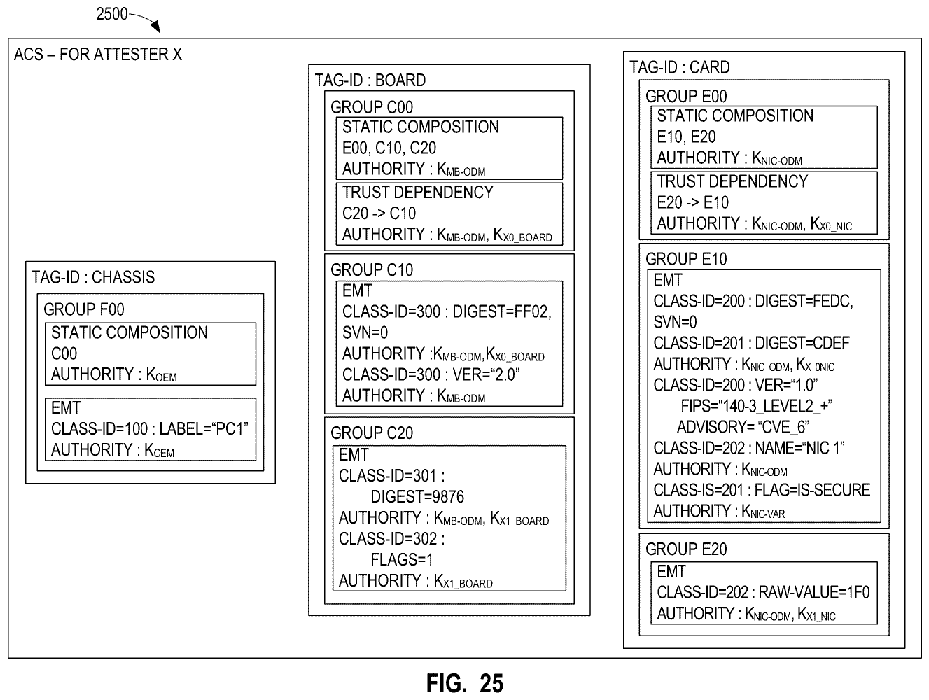

FIG. 25 illustrates an example ACS 2500 generated by the verifier circuitry 106 of FIG. 1 for an attester for the example conditional endorsement with authority use case of FIG. 24. The example ACS 2500 is the example ACS 2300 updated with the claims in the conditional endorsement 2402.

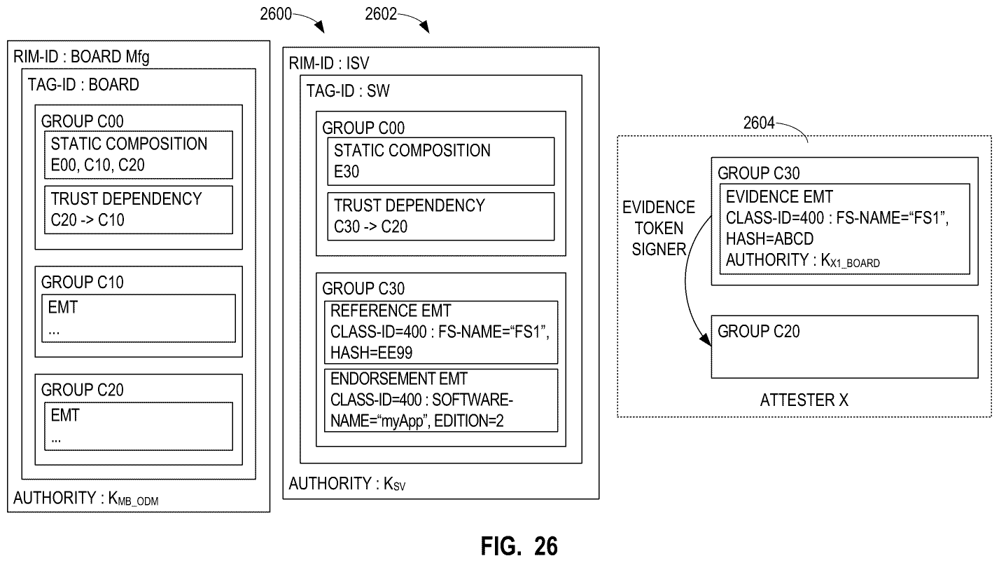

FIG. 26 illustrates example endorsements 2600 and reference values 2602 provided by an independent software vendor (ISV) for software of an attester and attestation evidence 2604 provided by the attester for an example concise SWID (CoSWID) matching use case. The verifier circuitry 106 accepts CoSWID evidence 2602 from into the ACS 2600. The verifier circuitry 106 matches reference values 2602 from the ISV to the ACS 2600 and accepts endorsements 2606 from the ISV into the ACS 2600.

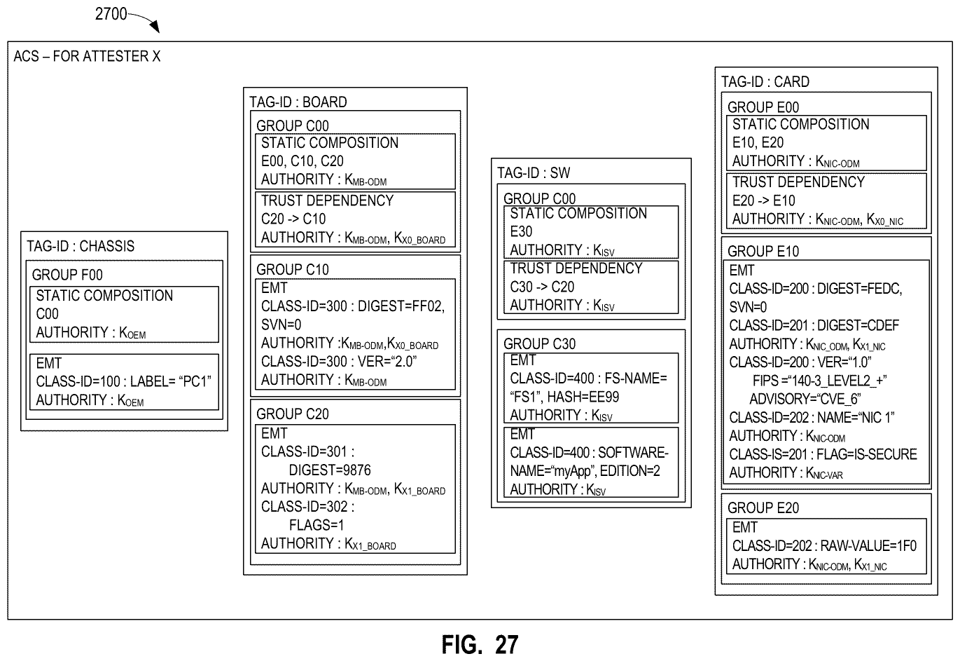

FIG. 27 illustrates an example ACS 2700 generated by the verifier circuitry 106 of FIG. 1 for an attester for the example CoSWID matching use case of FIG. 26. The example ACS 2700 is the example ACS 2500 updated with the claims in the CoSWID evidence 2602, the reference values 2604 and the endorsements 2606.

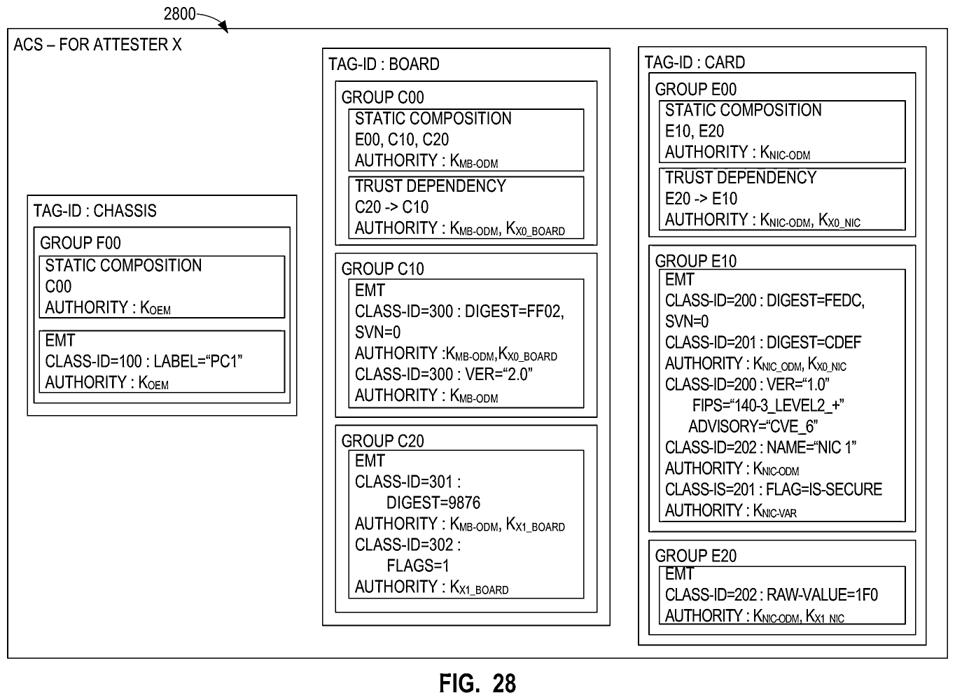

FIG. 28 illustrates an example ACS 2800 generated by the verifier circuitry 106 of FIG. 1 for an attester after the verifier circuitry 106 stages shown in FIGS. 8-27.

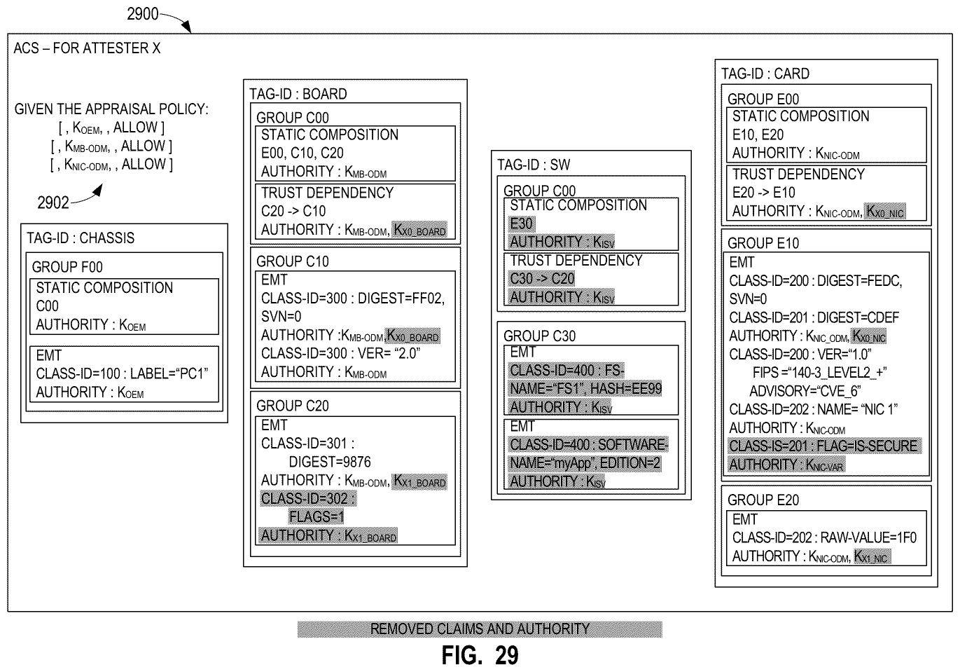

FIG. 29 illustrates an example ACS 2900 generated by the verifier circuitry 106 of FIG. 1 for an attester after application of an appraisal policy. In the illustrated example of FIG. 29, the appraisal policy directs the verifier circuitry 106 to remove claims and authority that are not associated with the authorities 2902.

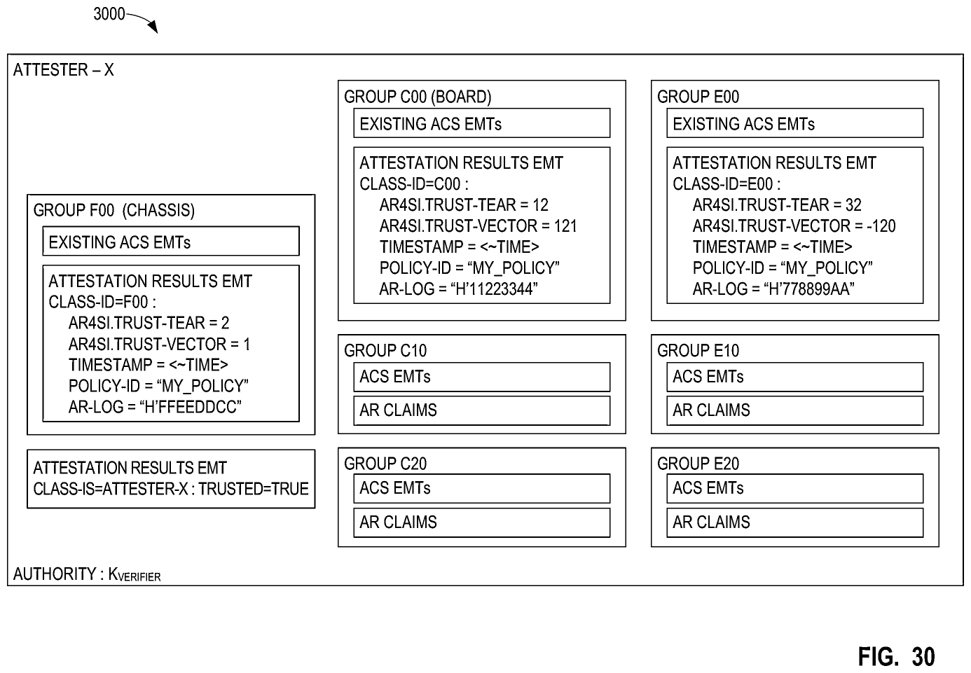

FIG. 30 illustrates example verifier asserted claims 3000 generated by the verifier circuitry 106 of FIG. 1. Verifier asserted claims are claims made by the verifier circuitry 106 about the attester. The verifier asserted claims include attestation results EMTs for the different groups in the ACS.

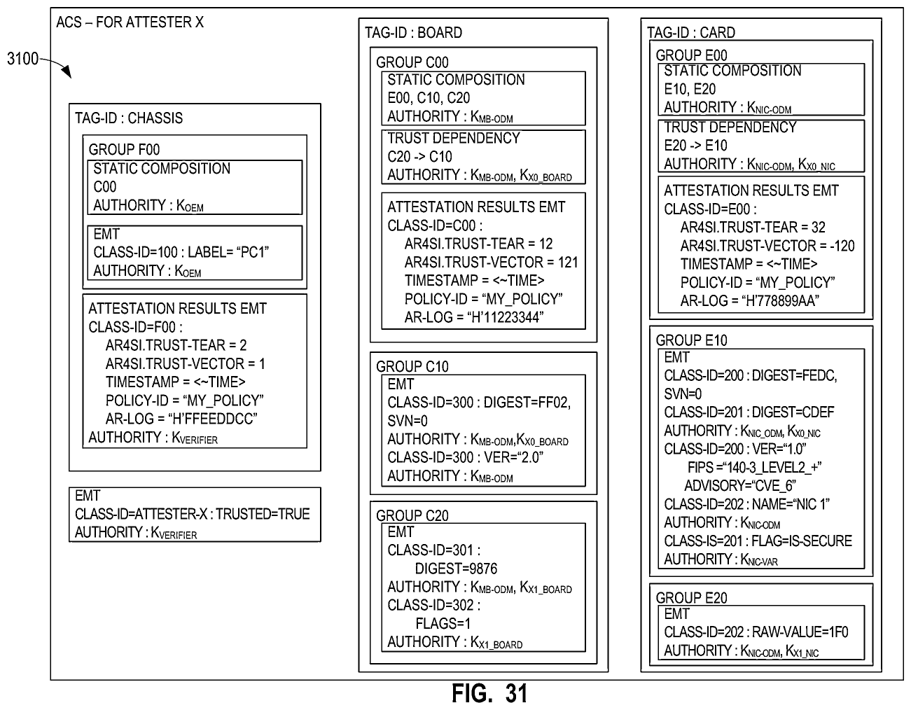

FIG. 31 illustrates an example final ACS 3100 generated by the verifier circuitry 106 of FIG. 1 for an attester in a final state. The verifier circuitry 106 generates attestation results for a relying party based on the final ACS 3100.

FIG. 32 is a block diagram of an example programmable circuitry platform 3200 structured to execute and/or instantiate the example machine-readable instructions and/or the example operations of FIGS. 4 and 5 to implement the verifier circuitry 106 of FIG. 2. The programmable circuitry platform 3200 can be, for example, a server, a personal computer, a workstation, a self-learning machine (e.g., a neural network), a mobile device (e.g., a cell phone, a smart phone, a tablet such as an iPad™), an Internet appliance, or any other type of computing and/or electronic device.

The programmable circuitry platform 3200 of the illustrated example includes programmable circuitry 3212. The programmable circuitry 3212 of the illustrated example is hardware. For example, the programmable circuitry 3212 can be implemented by one or more integrated circuits, logic circuits, FPGAs, microprocessors, CPUs, GPUs, DSPs, and/or microcontrollers from any desired family or manufacturer. The programmable circuitry 3212 may be implemented by one or more semiconductor based (e.g., silicon based) devices. In this example, the programmable circuitry 3212 implements the attestation evidence obtainer circuitry 202, the reference value obtainer circuitry 204, the endorsement obtainer circuitry 206, the appraisal context extractor circuitry 208, the node network generator circuitry 210, and the attestation results generator circuitry 212.

The programmable circuitry 3212 of the illustrated example includes a local memory 3213 (e.g., a cache, registers, etc.). The programmable circuitry 3212 of the illustrated example is in communication with main memory 3214, 3216, which includes a volatile memory 3214 and a non-volatile memory 3216, by a bus 3218. The volatile memory 3214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3216 may be implemented by flash memory and/or any other desired type of memory device. Access to the main memory 3214, 3216 of the illustrated example is controlled by a memory controller 3217. In some examples, the memory controller 3217 may be implemented by one or more integrated circuits, logic circuits, microcontrollers from any desired family or manufacturer, or any other type of circuitry to manage the flow of data going to and from the main memory 3214, 3216.

The programmable circuitry platform 3200 of the illustrated example also includes interface circuitry 3220. The interface circuitry 3220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3222 are connected to the interface circuitry 3220. The input device(s) 3222 permit(s) a user (e.g., a human user, a machine user, etc.) to enter data and/or commands into the programmable circuitry 3212. The input device(s) 3222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 3224 are also connected to the interface circuitry 3220 of the illustrated example. The output device(s) 3224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3220 of the illustrated example, thus, typically includes a graphics driver card, a graphics driver chip, and/or graphics processor circuitry such as a GPU.

The interface circuitry 3220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 3200 of the illustrated example also includes one or more mass storage discs or devices 3228 to store firmware, software, and/or data. Examples of such mass storage discs or devices 3228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 3232, which may be implemented by the machine readable instructions of FIGS. 4 and 5, may be stored in the mass storage device 3228, in the volatile memory 3214, in the non-volatile memory 3216, and/or on at least one non-transitory computer readable storage medium such as a CD or DVD which may be removable.

FIG. 33 is a block diagram of an example implementation of the programmable circuitry 3212 of FIG. 32. In this example, the programmable circuitry 3212 of FIG. 32 is implemented by a microprocessor 3300. For example, the microprocessor 3300 may be a general-purpose microprocessor (e.g., general-purpose microprocessor circuitry). The microprocessor 3300 executes some or all of the machine-readable instructions of the flowcharts of FIGS. 4 and 5 to effectively instantiate the circuitry of FIG. 2 as logic circuits to perform operations corresponding to those machine readable instructions. In some such examples, the circuitry of FIG. 2 is instantiated by the hardware circuits of the microprocessor 3300 in combination with the machine-readable instructions. For example, the microprocessor 3300 may be implemented by multi-core hardware circuitry such as a CPU, a DSP, a GPU, an XPU, etc. Although it may include any number of example cores 3302 (e.g., 1 core), the microprocessor 3300 of this example is a multi-core semiconductor device including N cores. The cores 3302 of the microprocessor 3300 may operate independently or may cooperate to execute machine readable instructions. For example, machine code corresponding to a firmware program, an embedded software program, or a software program may be executed by one of the cores 3302 or may be executed by multiple ones of the cores 3302 at the same or different times. In some examples, the machine code corresponding to the firmware program, the embedded software program, or the software program is split into threads and executed in parallel by two or more of the cores 3302. The software program may correspond to a portion or all of the machine readable instructions and/or operations represented by the flowcharts of FIGS. 4 and 5.

The cores 3302 may communicate by a first example bus 3304. In some examples, the first bus 3304 may be implemented by a communication bus to effectuate communication associated with one(s) of the cores 3302. For example, the first bus 3304 may be implemented by at least one of an Inter-Integrated Circuit (I2C) bus, a Serial Peripheral Interface (SPI) bus, a PCI bus, or a PCIe bus. Additionally or alternatively, the first bus 3304 may be implemented by any other type of computing or electrical bus. The cores 3302 may obtain data, instructions, and/or signals from one or more external devices by example interface circuitry 3306. The cores 3302 may output data, instructions, and/or signals to the one or more external devices by the interface circuitry 3306. Although the cores 3302 of this example include example local memory 3320 (e.g., Level 1 (L1) cache that may be split into an L1 data cache and an L1 instruction cache), the microprocessor 3300 also includes example shared memory 3310 that may be shared by the cores (e.g., Level 2 (L2 cache)) for high-speed access to data and/or instructions. Data and/or instructions may be transferred (e.g., shared) by writing to and/or reading from the shared memory 3310. The local memory 3320 of each of the cores 3302 and the shared memory 3310 may be part of a hierarchy of storage devices including multiple levels of cache memory and the main memory (e.g., the main memory 3214, 3216 of FIG. 32). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 3302 may be referred to as a CPU, DSP, GPU, etc., or any other type of hardware circuitry. Each core 3302 includes control unit circuitry 3314, arithmetic and logic (AL) circuitry (sometimes referred to as an ALU) 3316, a plurality of registers 3318, the local memory 3320, and a second example bus 3322. Other structures may be present. For example, each core 3302 may include vector unit circuitry, single instruction multiple data (SIMD) unit circuitry, load/store unit (LSU) circuitry, branch/jump unit circuitry, floating-point unit (FPU) circuitry, etc. The control unit circuitry 3314 includes semiconductor-based circuits structured to control (e.g., coordinate) data movement within the corresponding core 3302. The AL circuitry 3316 includes semiconductor-based circuits structured to perform one or more mathematic and/or logic operations on the data within the corresponding core 3302. The AL circuitry 3316 of some examples performs integer based operations. In other examples, the AL circuitry 3316 also performs floating-point operations. In yet other examples, the AL circuitry 3316 may include first AL circuitry that performs integer-based operations and second AL circuitry that performs floating-point operations. In some examples, the AL circuitry 3316 may be referred to as an Arithmetic Logic Unit (ALU).

The registers 3318 are semiconductor-based structures to store data and/or instructions such as results of one or more of the operations performed by the AL circuitry 3316 of the corresponding core 3302. For example, the registers 3318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 3318 may be arranged in a bank as shown in FIG. 33. Alternatively, the registers 3318 may be organized in any other arrangement, format, or structure, such as by being distributed throughout the core 3302 to shorten access time. The second bus 3322 may be implemented by at least one of an I2C bus, a SPI bus, a PCI bus, or a PCIe bus.

Each core 3302 and/or, more generally, the microprocessor 3300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 3300 is a semiconductor device fabricated to include many transistors interconnected to implement the structures described above in one or more integrated circuits (ICs) contained in one or more packages.

The microprocessor 3300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 3300, in the same chip package as the microprocessor 3300 and/or in one or more separate packages from the microprocessor 3300.

FIG. 34 is a block diagram of another example implementation of the programmable circuitry 3212 of FIG. 32. In this example, the programmable circuitry 3212 is implemented by FPGA circuitry 3400. For example, the FPGA circuitry 3400 may be implemented by an FPGA. The FPGA circuitry 3400 can be used, for example, to perform operations that could otherwise be performed by the example microprocessor 3300 of FIG. 33 executing corresponding machine readable instructions. However, once configured, the FPGA circuitry 3400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 3300 of FIG. 33 described above (which is a general purpose device that may be programmed to execute some or all of the machine readable instructions represented by the flowcharts of FIGS. 4 and 5 but whose interconnections and logic circuitry are fixed once fabricated), the FPGA circuitry 3400 of the example of FIG. 34 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4 and 5. In particular, the FPGA circuitry 3400 may be thought of as an array of logic gates, interconnections, and switches. The switches can be programmed to change how the logic gates are interconnected by the interconnections, effectively forming one or more dedicated logic circuits (unless and until the FPGA circuitry 3400 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4 and 5. As such, the FPGA circuitry 3400 may be configured and/or structured to effectively instantiate some or all of the operations/functions corresponding to the machine readable instructions of the flowcharts of FIGS. 4 and 5 as dedicated logic circuits to perform the operations/functions corresponding to those software instructions in a dedicated manner analogous to an ASIC. Therefore, the FPGA circuitry 3400 may perform the operations/functions corresponding to the some or all of the machine readable instructions of FIGS. 4 and 5 faster than the general-purpose microprocessor can execute the same.

In the example of FIG. 34, the FPGA circuitry 3400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 3400 of FIG. 34 may access and/or load the binary file to cause the FPGA circuitry 3400 of FIG. 34 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3400 of FIG. 34 to cause configuration and/or structuring of the FPGA circuitry 3400 of FIG. 34, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 3400 of FIG. 34 may access and/or load the binary file to cause the FPGA circuitry 3400 of FIG. 34 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3400 of FIG. 34 to cause configuration and/or structuring of the FPGA circuitry 3400 of FIG. 34, or portion(s) thereof.

The FPGA circuitry 3400 of FIG. 34, includes example input/output (I/O) circuitry 3402 to obtain and/or output data to/from example configuration circuitry 3404 and/or external hardware 3406. For example, the configuration circuitry 3404 may be implemented by interface circuitry that may obtain a binary file, which may be implemented by a bit stream, data, and/or machine-readable instructions, to configure the FPGA circuitry 3400, or portion(s) thereof. In some such examples, the configuration circuitry 3404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 3406 may be implemented by external hardware circuitry. For example, the external hardware 3406 may be implemented by the microprocessor 3300 of FIG. 33.

The FPGA circuitry 3400 also includes an array of example logic gate circuitry 3408, a plurality of example configurable interconnections 3410, and example storage circuitry 3412. The logic gate circuitry 3408 and the configurable interconnections 3410 are configurable to instantiate one or more operations/functions that may correspond to at least some of the machine readable instructions of FIGS. 4 and 5 and/or other desired operations. The logic gate circuitry 3408 shown in FIG. 34 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 3408 to enable configuration of the electrical structures and/or the logic gates to form circuits to perform desired operations/functions. The logic gate circuitry 3408 may include other electrical structures such as look-up tables (LUTs), registers (e.g., flip-flops or latches), multiplexers, etc.

The configurable interconnections 3410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 3408 to program desired logic circuits.

The storage circuitry 3412 of the illustrated example is structured to store result(s) of the one or more of the operations performed by corresponding logic gates. The storage circuitry 3412 may be implemented by registers or the like. In the illustrated example, the storage circuitry 3412 is distributed amongst the logic gate circuitry 3408 to facilitate access and increase execution speed.

The example FPGA circuitry 3400 of FIG. 34 also includes example dedicated operations circuitry 3414. In this example, the dedicated operations circuitry 3414 includes special purpose circuitry 3416 that may be invoked to implement commonly used functions to avoid the need to program those functions in the field. Examples of such special purpose circuitry 3416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 3400 may also include example general purpose programmable circuitry 3418 such as an example CPU 3420 and/or an example DSP 3422. Other general purpose programmable circuitry 3418 may additionally or alternatively be present such as a GPU, an XPU, etc., that can be programmed to perform other operations.

Although FIGS. 33 and 34 illustrate two example implementations of the programmable circuitry 3212 of FIG. 32, many other approaches are contemplated. For example, FPGA circuitry may include an on-board CPU, such as one or more of the example CPU 3420 of FIG. 33. Therefore, the programmable circuitry 3212 of FIG. 32 may additionally be implemented by combining at least the example microprocessor 3300 of FIG. 33 and the example FPGA circuitry 3400 of FIG. 34. In some such hybrid examples, one or more cores 3302 of FIG. 33 may execute a first portion of the machine readable instructions represented by the flowcharts of FIGS. 4 and 5 to perform first operation(s)/function(s), the FPGA circuitry 3400 of FIG. 34 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. 2 may, thus, be instantiated at the same or different times. For example, same and/or different portion(s) of the microprocessor 3300 of FIG. 33 may be programmed to execute portion(s) of machine-readable instructions at the same and/or different times. In some examples, same and/or different portion(s) of the FPGA circuitry 3400 of FIG. 34 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 3300 of FIG. 33 may execute machine readable instructions in one or more threads executing concurrently and/or in series. In some examples, the FPGA circuitry 3400 of FIG. 34 may be configured and/or structured to carry out operations/functions concurrently and/or in series. Moreover, in some examples, some or all of the circuitry of FIG. 2 may be implemented within one or more virtual machines and/or containers executing on the microprocessor 3300 of FIG. 33.

In some examples, the programmable circuitry 3212 of FIG. 32 may be in one or more packages. For example, the microprocessor 3300 of FIG. 33 and/or the FPGA circuitry 3400 of FIG. 34 may be in one or more packages. In some examples, an XPU may be implemented by the programmable circuitry 3212 of FIG. 32, which may be in one or more packages. For example, the XPU may include a CPU (e.g., the microprocessor 3300 of FIG. 33, the CPU 3420 of FIG. 34, etc.) in one package, a DSP (e.g., the DSP 3422 of FIG. 34) in another package, a GPU in yet another package, and an FPGA (e.g., the FPGA circuitry 3400 of FIG. 34) in still yet another package.

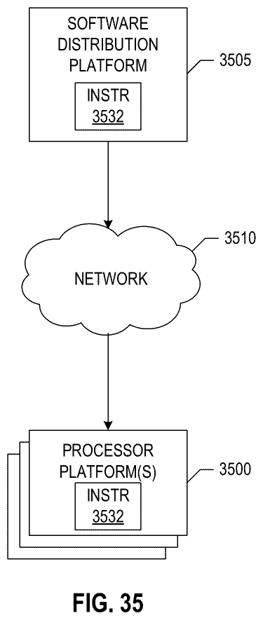

A block diagram illustrating an example software distribution platform 3505 to distribute software such as the example machine readable instructions 3232 of FIG. 32 to other hardware devices (e.g., hardware devices owned and/or operated by third parties from the owner and/or operator of the software distribution platform) is illustrated in FIG. 35. The example software distribution platform 3505 may be implemented by any computer server, data facility, cloud service, etc., capable of storing and transmitting software to other computing devices. The third parties may be customers of the entity owning and/or operating the software distribution platform 3505. For example, the entity that owns and/or operates the software distribution platform 3505 may be a developer, a seller, and/or a licensor of software such as the example machine readable instructions 3232 of FIG. 32. The third parties may be consumers, users, retailers, OEMs, etc., who purchase and/or license the software for use and/or re-sale and/or sub-licensing. In the illustrated example, the software distribution platform 3505 includes one or more servers and one or more storage devices. The storage devices store the machine readable instructions 3232, which may correspond to the example machine readable instructions of FIGS. 4 and 5, as described above. The one or more servers of the example software distribution platform 3505 are in communication with an example network 3510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 3232 from the software distribution platform 3505. For example, the software, which may correspond to the example machine readable instructions of FIGS. 4 and 5, may be downloaded to the example programmable circuitry platform 3200, which is to execute the machine readable instructions 3232 to implement the verifier circuitry 106. In some examples, one or more servers of the software distribution platform 3505 periodically offer, transmit, and/or force updates to the software (e.g., the example machine readable instructions 3232 of FIG. 32) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that produce a detailed representation of an operating state of an attester device to generate reliable attestation results from attestation evidence, reference values, and endorsements in various formats. Example systems, apparatus, articles of manufacture, and methods disclosed herein extract appraisal context information from attestation evidence, reference values, and endorsements to generate appraisal context metadata for use in generation of networks of nodes. Example systems, apparatus, articles of manufacture, and methods disclosed herein generate networks of nodes combining top down and bottom up descriptions of an operating state of an attester device to generate attestation results. Disclosed systems, apparatus, articles of manufacture, and methods improve the efficiency of using a computing device by generating a topological description of the attester using appraisal context information, reducing computational waste by preventing redundant requests for information from the attester and/or suppliers. Disclosed systems, apparatus, articles of manufacture, and methods are accordingly directed to one or more improvement(s) in the operation of a machine such as a computer or other electronic and/or mechanical device.

Further examples and combinations thereof include the following:

Example 1 includes at least one non-transitory computer readable medium comprising instructions that, when executed, cause a machine to at least: determine a first network of nodes from attestation evidence, a node of the first network of nodes associated with an appraisal context of a device; obtain an endorsement for the device; determine a second network of nodes from the endorsements; identify a node that is in the first network of nodes and the second network of nodes; combine the first network of nodes and the second network of nodes to form a third network of nodes; and generate an attestation result for the device from the third network of nodes.

Example 2 includes the storage medium of example 1, wherein the instructions, when executed, cause the machine to create a parent node that is common to the first network of nodes and the second network of nodes to combine the first network of nodes and the second network of nodes.

Example 3 includes the storage medium of any of examples 1 or 2, wherein the instructions, when executed, cause the machine to determine that the second network of nodes is associated with the device.

Example 4 includes the storage medium of any of examples 1-3, wherein the first network of nodes has a first type and the second network of nodes has a second type that is different than the first type.

Example 5 includes the storage medium of any of examples 1-4, wherein the first type is a top down hierarchy and the second type is a bottom up hierarchy.

Example 6 includes the storage medium of any of examples 1-5, wherein the bottom up hierarchy starts with a root of trust.

Example 7 includes the storage medium of any of examples 1-6, wherein the top down hierarchy starts with a device platform and includes a plurality of sub-components of the device platform.

Example 8 includes a method including determining a first network of nodes from attestation evidence, a node of the first network of nodes associated with an appraisal context of a device; obtaining an endorsement for the device; determining a second network of nodes from the endorsements; identifying a node that is in the first network of nodes and the second network of nodes; combining the first network of nodes and the second network of nodes to form a third network of nodes; and generating an attestation result for the device from the third network of nodes.

Example 9 includes the method of example 8, further including creating a parent node that is common to the first network of nodes and the second network of nodes to combine the first network of nodes and the second network of nodes.

Example 10 includes the method of any of examples 8 or 9, further including determining that the second network of nodes is associated with the device.

Example 11 includes the method of any of examples 8-10, wherein the first network of nodes has a first type and the second network of nodes has a second type that is different than the first type.

Example 12 includes the method of any of examples 8-11, wherein the first type is a top down hierarchy and the second type is a bottom up hierarchy.

Example 13 includes the method of any of examples 8-12, wherein the bottom up hierarchy starts with a root of trust.

Example 14 includes the method of any of examples 8-13, wherein the top down hierarchy starts with a device platform and includes a plurality of sub-components of the device platform.

Example 15 includes an apparatus including instructions; and processor circuitry to execute the instructions to: determine a first network of nodes from attestation evidence, a node of the first network of nodes associated with an appraisal context of an device; obtain an endorsement for the device; determine a second network of nodes from the endorsements; identify a node that is in the first network of nodes and the second network of nodes; combine the first network of nodes and the second network of nodes to form a third network of nodes; and generate an attestation result for the device from the third network of nodes.

Example 16 includes the apparatus of example 15, wherein the processor circuitry is to create a parent node that is common to the first network of nodes and the second network of nodes to combine the first network of nodes and the second network of nodes.

Example 17 includes the apparatus of any of examples 15 or 16, wherein the processor circuitry is to determine that the second network of nodes is associated with the device.

Example 18 includes the apparatus of any of examples 15-17, wherein the first network of nodes has a first type and the second network of nodes has a second type that is different than the first type.

Example 19 includes the apparatus of any of examples 15-18, wherein the first type is a top down hierarchy and the second type is a bottom up hierarchy.

Example 20 includes the apparatus of any of examples 15-19, wherein the bottom up hierarchy starts with a root of trust.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory computer readable medium comprising instructions that, when executed, cause a machine to at least:
determine a first network of nodes from attestation evidence, a node of the first network of nodes associated with an appraisal context of a device;
obtain an endorsement for the device;
determine a second network of nodes from the endorsements;
identify a node that is in the first network of nodes and the second network of nodes;
combine the first network of nodes and the second network of nodes to form a third network of nodes; and
generate an attestation result for the device from the third network of nodes.

2. The non-transitory computer readable medium of claim 1, wherein the instructions, when executed, cause the machine to create a parent node that is common to the first network of nodes and the second network of nodes to combine the first network of nodes and the second network of nodes.

3. The non-transitory computer readable medium of claim 1, wherein the instructions, when executed, cause the machine to determine that the second network of nodes is associated with the device.

4. The non-transitory computer readable medium of claim 1, wherein the first network of nodes has a first type and the second network of nodes has a second type that is different than the first type.

5. The non-transitory computer readable medium of claim 4, wherein the first type is a top down hierarchy and the second type is a bottom up hierarchy.

6. The non-transitory computer readable medium of claim 5, wherein the bottom up hierarchy starts with a root of trust.

7. The non-transitory computer readable medium of claim 5, wherein the top down hierarchy starts with a device platform and includes a plurality of sub-components of the device platform.

8. A method comprising:
determining a first network of nodes from attestation evidence, a node of the first network of nodes associated with an appraisal context of a device;
obtaining an endorsement for the device;
determining a second network of nodes from the endorsements;
identifying a node that is in the first network of nodes and the second network of nodes;
combining the first network of nodes and the second network of nodes to form a third network of nodes; and
generating an attestation result for the device from the third network of nodes.

9. The method of claim 8, further including creating a parent node that is common to the first network of nodes and the second network of nodes to combine the first network of nodes and the second network of nodes.

10. The method of claim 8, further including determining that the second network of nodes is associated with the device.

11. The method of claim 8, wherein the first network of nodes has a first type and the second network of nodes has a second type that is different than the first type.

12. The method of claim 11, wherein the first type is a top down hierarchy and the second type is a bottom up hierarchy.

13. The method of claim 12, wherein the bottom up hierarchy starts with a root of trust.

14. The method of claim 12, wherein the top down hierarchy starts with a device platform and includes a plurality of sub-components of the device platform.

15. An apparatus comprising:
instructions; and
processor circuitry to execute the instructions to:
determine a first network of nodes from attestation evidence, a node of the first network of nodes associated with an appraisal context of a device;
obtain an endorsement for the device;
determine a second network of nodes from the endorsements;
identify a node that is in the first network of nodes and the second network of nodes;
combine the first network of nodes and the second network of nodes to form a third network of nodes; and
generate an attestation result for the device from the third network of nodes.

16. The apparatus of claim 15, wherein the processor circuitry is to create a parent node that is common to the first network of nodes and the second network of nodes to combine the first network of nodes and the second network of nodes.

17. The apparatus of claim 15, wherein the processor circuitry is to determine that the second network of nodes is associated with the device.

18. The apparatus of claim 15, wherein the first network of nodes has a first type and the second network of nodes has a second type that is different than the first type.

19. The apparatus of claim 18, wherein the first type is a top down hierarchy and the second type is a bottom up hierarchy.

20. The apparatus of claim 19, wherein the bottom up hierarchy starts with a root of trust.
